(19) United States
(12) Patent Application Publication
(10) Pub. No.: US 2013/0250568 A1
(43) Pub. Date: Sep. 26, 2013

(54) DISPLAY APPARATUS AND ELECTRONIC APPARATUS

(71) Applicant: JAPAN DISPLAY WEST, INC., Aichi-Ken (JP)

(72) Inventors: Takeo Koito, Kanagawa (JP); Daisuke Takama, Kanagawa (JP)

(73) Assignee: JAPAN DISPLAY WEST, INC., Aichi-Ken (JP)

(21) Appl. No.: 13/772,513

(22) Filed: Feb. 21, 2013

(30) Foreign Application Priority Data
Mar. 23, 2012 (JP) 2012-067937

(51) Int. Cl. F21V 9/00

(52) U.S. Cl. CPC F21V 9/00
USPC 362/231

(57) ABSTRACT

Disclosed herein is a display apparatus including a display section in which pixels each configured from a plurality of sub pixels of colors different from each other are disposed; and an optical device laminated on the display section and configured to control a direction of a light ray from the display section; wherein the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

### BACKGROUND

The present disclosure relates to a display apparatus and an electronic apparatus. More particularly, the present disclosure relates to a display apparatus and an electronic apparatus wherein a 2D image, a 3D image and a multi-view image can be provided without degradation of the picture quality.

In recent years, attention has been and is being paid to three-dimensional (3D) video content based on which a video can be visually recognized as a stereoscopic image. As an appreciation method of a three-dimensional video, a binocular parallax method by which a left eye video and a right eye video having a parallax therebetween are appreciated by a viewer is being popularized. As a binocular parallax method, an eyeglasses method which uses eyeglasses and a naked eye method which does not use eyeglasses are available.

As the naked eye method, a lenticular screen method, a parallax barrier method and so forth are available. According to the lenticular screen method, barrel type fine lenses (lenticular lenses) are disposed to separate a light path for a left eye video and a light path for a right eye video from each other. Meanwhile, according to the parallax barrier method, a light path for a left eye video and a light path for a right eye video are separated from each other by vertical slits, namely, by a parallax barrier.

In this manner, the parallax barrier method, lens method and so forth predominate as a technique for naked eye 3D display. In those methods, a barrier or lenses are disposed in front of a display apparatus such that the direction of light is controlled thereby so that, in the case of 2-parallax 3D display, pixels of the display apparatus are distributed to the right eye and the left eye. Further, in the case of a multiple parallax method, the pixels of the display apparatus are distributed in response to viewpoint positions for one-parallax display, two-parallax display, three-parallax display and so forth.

Upon such pixel distribution, depending upon the color disposition, the color of visible pixels is deviated by the viewing position and the picture sometimes becomes colorized. In order to prevent such colorization, it has been proposed by Japanese Patent Laid-Open No. 2007-183611 to eliminate such color deviation to prevent colorization of a 3D image.

### SUMMARY

Although Japanese Patent Laid-Open No. 2007-183611 mentioned above proposes to eliminate the color deviation to prevent colorization of a 3D image, there is the possibility that, in the case of a 2D image, the picture quality may rather be deteriorated because of a color deviation arising from a deviation of pixels, for example, from local disposition of a predetermined color. In recent years, an apparatus which can provide both of a 2D image and a 3D image has been and is being popularized, and it is demanded to improve the picture quality of both of a 2D image and a 3D image.

Therefore, it is desirable to provide a display apparatus and an electronic apparatus which can provide a 2D image of high picture quality and a 3D image which is free from colorization.

According to an embodiment of the present technology, there is provided a display apparatus including a display section in which pixels each configured from a plurality of sub pixels of colors different from each other are disposed, and an optical device laminated on the display section and configured to control a direction of a light ray from the display section, wherein the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

The display apparatus may be configured such that each of the pixels is configured from sub pixels of the four colors disposed in a 2×2 matrix, and the pixels are disposed at positions displaced by a distance of a sub pixel for each row in a unit of the pixel.

In this instance, the display apparatus may be configured such that the optical device includes an opening for allowing the light ray from the display section to pass to a predetermined direction therethrough, and the opening has a linear shape in a vertical, horizontal or oblique direction having a width substantially equal to that of a sub pixel or another width of a substantially integral multiple of that of the sub pixel.

Where all of the colors of the sub pixels exhibit the repetitions in the vertical direction of the display section, the disposition of the sub pixels may be different between the columns adjacent each other.

The sub pixels of the same colors may be disposed successively in an obliquely leftward direction or an obliquely rightward direction.

The display apparatus may be configured such that each of the pixels is configured from sub pixels of the four colors disposed in a 2×2 matrix, and the pixels include first pixels and second pixels between which the disposition of the colors of the sub pixels differs from each other and which are disposed in the vertical direction separately from each other and are disposed alternately in the horizontal direction.

The sub pixels which configure one pixel may be disposed successively in an obliquely leftward direction or an obliquely rightward direction.

In this instance, the display apparatus may be configured such that the optical device has an opening or openings for allowing the light ray from the display section to pass to the predetermined direction therethrough and the opening has a stepped shape, and the size of one opening is equal to that of one or a plurality of sub pixels.

Spacers may be disposed in a direction same as the direction in which the sub pixels of the same colors are disposed.

In this instance, the display apparatus may be configured such that the optical device has an opening or openings for allowing the light ray from the display section pass to the predetermined direction therethrough, and the spacers are disposed uniformly in the openings.

The pixels of the display section may be disposed in a dual domain structure.

According to another embodiment of the present technology, there is provided an electronic apparatus including a display section in which pixels each configured from a plurality of sub pixels of colors different from each other are disposed, and an optical device laminated on the display section and configured to control a direction of a light ray from the display section, wherein the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

In the display apparatus and the electronic apparatus according to the present technology, the display section in which pixels each configured from a plurality of sub pixels of colors different from each other are disposed and the optical device laminated on the display section and configured to control a direction of a light ray from the display section are provided. Further, the sub pixels are disposed at the positions at which repetitions of all of the colors of the sub pixels are provided in at least one of the horizontal direction and the vertical direction of the display section and the distances between the sub pixels having the same colors and adjacent from each other are substantially equal to each other.

With the display apparatus and the electronic apparatus according to the present technology, a 2D image of high picture quality and a 3D image free from colorization can be provided.

The above and other objects, features and advantages of the present technology will become apparent from the following description and the appended claims, taken in conjunction with the accompanying drawings in which like parts or elements denoted by like reference characters.

### BRIEF DESCRIPTION OF THE DRAWINGS

FIG. 1 is a schematic view illustrating a configuration of a display apparatus;

FIG. 2 is a schematic view illustrating a parallax barrier method;

FIG. 3 is a schematic view illustrating a point of view;

FIGS. 4A to 4C are views illustrating a relationship between a disposition state of sub pixels and a barrier;

FIGS. 5A to 5C, 6A to 6C and 7A to 7C are views illustrating different relationships between a disposition state of sub pixels and a barrier;

FIGS. 8A and 8B, 9, 10A and 10B, and 11 are views illustrating different dispositions of sub pixels;

FIGS. 12A to 12C and 13A to 13C are views illustrating different relationships between a disposition state of sub pixels and a barrier;

FIGS. 14A and 14B are views illustrating a disposition state of sub pixels;

FIGS. 15A to 15C, 16A to 16C and 17A to 17C are views illustrating different relationships between a disposition state of sub pixels and a barrier;

FIGS. 18A to 18C are views illustrating a disposition state of sub pixels in a dual domain structure; and

FIG. 19 is a schematic view showing a display apparatus.

### DETAILED DESCRIPTION OF THE PREFERRED EMBODIMENT

In the following, an embodiment of the present technology is described with reference to the accompanying drawings.

The present technology described below can be applied to an apparatus which displays a stereoscopic image. A stereoscopic image may be any of moving images and static images. Further, in the present embodiment, the present technology is applied to a display apparatus which provides a stereoscopic image when it is viewed with naked eyes. Further, as a method for providing a stereoscopic image with naked eyes, a parallax barrier method is described as an example in the following description.

It is to be noted that the present embodiment described hereinbelow can be applied also to a method different from the parallax barrier method such as, for example, a lenticular screen method. Further, in regard to the barrier, the present embodiment described hereinbelow can be applied not only to a light blocking barrier but also to a barrier of the type which creates a viewpoint by switching using liquid crystal or the like or to liquid crystal lenses.

In other words, the present technology can be applied to an apparatus which distributes light to carry out two-screen display, namely, display of multiple viewpoints, stereoscopic display or the like.

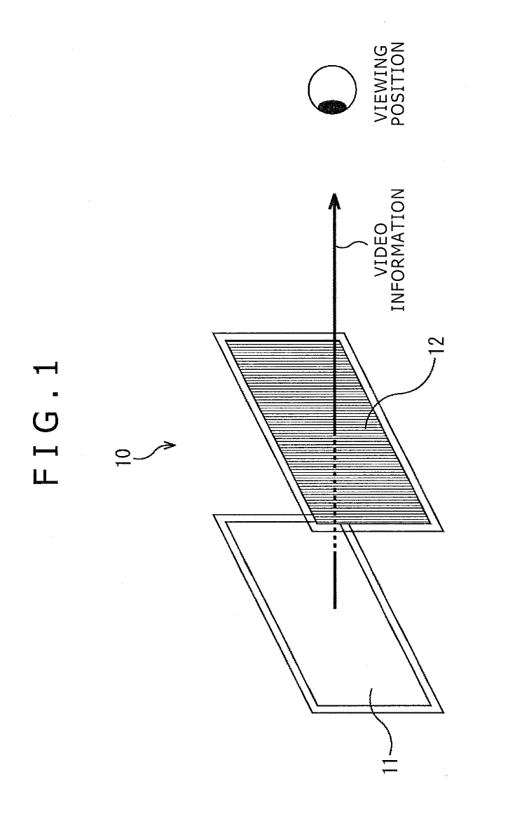

FIG. 1 shows a detailed configuration of a display section of a display apparatus 10 for displaying a stereoscopic image. Referring to FIG. 1, the display apparatus 10 is configured from a display section 11 for displaying an image, a video and so forth, and a parallax barrier 12 provided on the viewer side of the display section 11. In particular, the parallax barrier 12 of a shape same as that of the display section 11 is mounted on a display face of the display section 11.

The parallax barrier 12 has slits of a predetermined shape. The viewer would view an image displayed on the display section 11 through the parallax barrier 12. On the display section 11, left eye pixels for displaying an image as viewed from the left eye when the display section 11 is viewed from a predetermined viewing position and right eye pixels for displaying an image as viewed from the right eye are disposed alternately. It is to be noted that, although the following description is given principally taking a case in which a stereoscopic image is provided to the viewer as an example, since the present technology can be applied also to a case in which different images are provided to a plurality of viewers, namely, in which multi-view images are provided, description is given suitably taking a case of multi-viewpoints as an example.

### Parallax Barrier Method

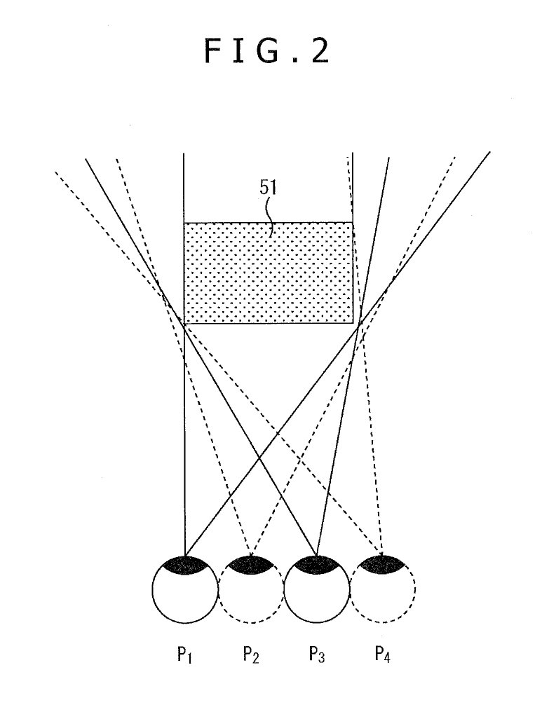

Here, the parallax barrier method is described. FIG. 2 illustrates a parallax barrier method which involves four viewpoints. The four viewpoints are a viewpoint P1, another viewpoint P2, a further viewpoint P3 and a still further viewpoint P4 in FIG. 2. The appearance of a viewing object 51 differs among the four viewpoints. Videos at the viewpoints are displayed on the display section 11.

If the viewpoint P1 from among the viewpoints P1 to P4 shown in FIG. 2 is that for the left eye, then the viewpoint P3 is that for the right eye. Since a person usually views the same object, in this instance, the viewing object 51, with the left eye and the right eye, preferably a video when viewed from the viewpoint P1 and another video when viewed from the viewpoint P3 are provided as videos to the viewer. Similarly, when the viewpoint P2 from among the viewpoints P1 to P4 shown in FIG. 2 is that for the left eye, the viewpoint P4 is that for the right eye. Therefore, in this instance, a video when viewed from the viewpoint P2 and another video when viewed from the viewpoint P4 are preferably provided to the viewer.

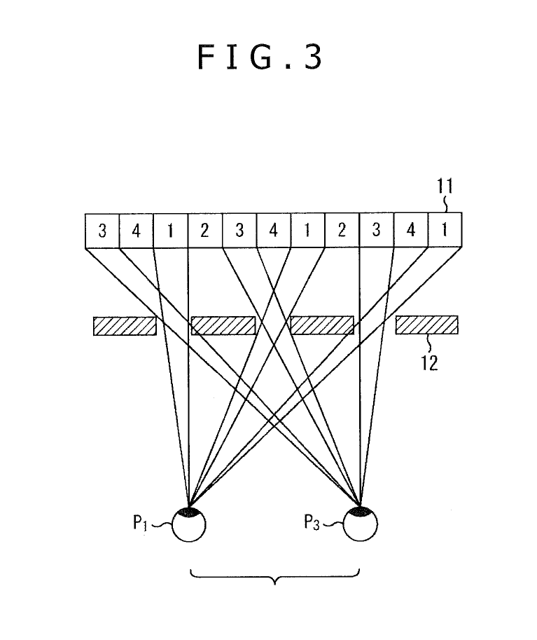

In this manner, when a plurality of videos of different viewpoints are provided, the combination of videos to be viewed at the same time by the viewer is significant. Thus, control is carried out by the display section 11 and the parallax barrier 12 so that videos of a correct combination may be viewed by the viewer. Although the display section 11 has openings of the parallax barrier 12, where the openings of the parallax barrier 12 have a linear shape, a number of parallax images corresponding to the number of the viewpoints are juxtaposed alternately such that they extend long in the upward and downward direction. In FIGS. 2 and 3, a case is exemplified in which the display section 11 and so forth are viewed from above. The parallax barrier 12 is installed on this side, namely, on the viewer side, of the parallax barrier 12 as shown in FIG. 3.

Referring to FIG. 3, when the viewpoints of the viewer are positioned at correct viewing positions, if the left eye is positioned at the viewpoint P1, then parallax images 1 can be seen from the left eye, and if the right eye is positioned at the viewpoint P3, then parallax images 3 can be seen from the right eye. On the other hand, in the case of a multi-screen method wherein a plurality of images are provided to different viewers, if the parallax images 1 are provided to a viewer 1 and the parallax images 2 are provided to another viewer 2 while the parallax images 3 are provided to a further viewer 3 and the parallax images 4 are provided to a still further viewer 4, then the different images or videos can be supplied to the different viewers.

It is to be noted that, while FIG. 3 illustrates the case in which four viewpoints are involved as an example, a different number of viewpoints, for example, six or more viewpoints, may be provided. The number of viewpoints may be great in such a case that a stereoscopic image is supplied to multi-viewpoints or in a like case. It is to be noted that, although description of such supply of a stereoscopic image to multi-viewpoints is not given here, also in this instance, the present technology described below can be applied.

It is to be noted that, while the following description is directed to an example wherein a three-dimensional image is provided to one viewer, the present technology can be applied also where two-dimensional images are supplied to a plurality of viewers such as multi-screens or multi-viewpoints or where three-dimensional images are provided.

### Disposition of the Pixels

The display section 11 in the present embodiment can be applied to a display apparatus wherein one pixel is configured from four sub pixels which output light of different colors of R (red), G (green), B (blue) and W (white). In the following description, a display region which forms a minimum unit which configures a display image is referred to as “sub pixel,” and a display region configured from one set of sub pixels of R, G, B and W is referred to as “pixel.”

It is to be noticed that, while the following description continues taking a case in which one pixel is configured from four sub pixels of R (red), G (Green), B (blue) and W (white) as an example, the present technology can be applied also to the display section 11 wherein one pixel is configured from any other combination of sub pixels. For example, the present technology can be applied also to a case in which one pixel is configured from three sub pixels of three colors of R (red), G (Green) and B (blue), another case in which one pixel is configured from four sub pixels of four colors of R (red), G (Green), B (blue) and Y (yellow) or a further case in which one pixel is configured from sub pixels of three colors of C (cyan), M (magenta) and Y (yellow).

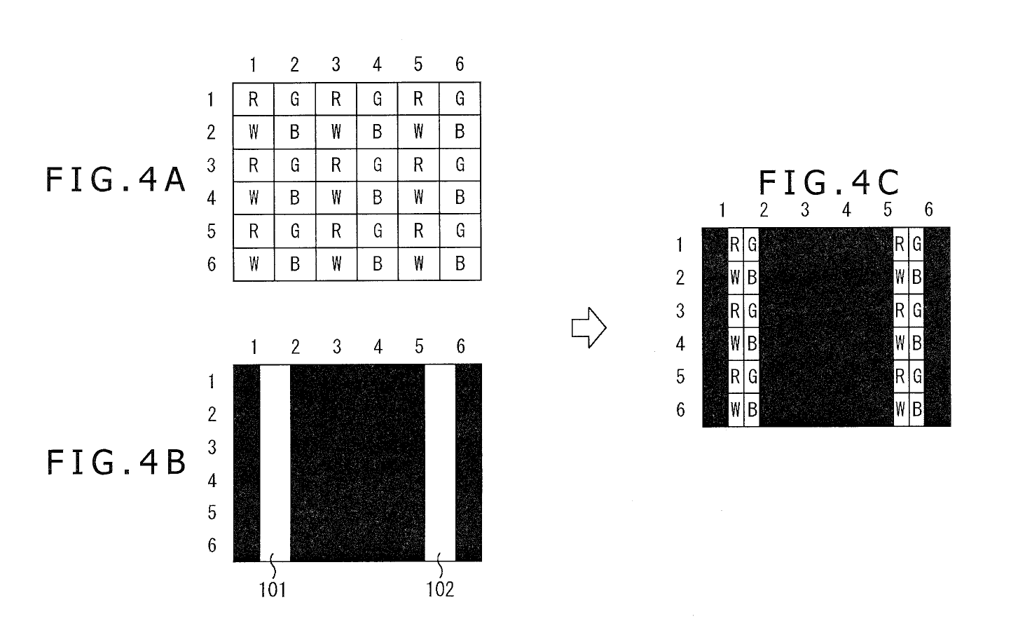

On the display section 11, a plurality of sub pixels R, G, B and W are disposed in a matrix in the display region, for example, as shown in FIG. 4A. In FIGS. 4A to 4C and figures referred to in the following description, R represents a sub pixel R, G a sub pixel G, B a sub pixel, and W a sub pixel W.

The term “sub pixel R” represents a sub pixel of red; “sub pixel G” a sub pixel of green; “sub pixel B” a sub pixel of blue; and “sub pixel W” a sub pixel of white.

As a representation for representing a position of a sub pixel, such a representation as sub pixel 1-2 is used. In the representation of sub pixel 1-2, “1” represents that the sub pixel is positioned at the first position when the sub pixels are counted in the horizontal direction from the left side in the figure. Meanwhile, “2” represents that the sub pixel is positioned at the second position when the sub pixels are counted in the vertical direction from the upper side in the figure. For example, the sub pixel 1-1 indicates the sub pixel R at the first position from the left at the first position from above in FIG. 4A. Similarly, for example, the sub pixel 4-1 indicates the sub pixel W at the fourth position from the left at the first position from above in FIG. 4A.

Such a representation as described above is applied also to the parallax barrier 12. For example, the representation “opening 1-4 of the parallax barrier 12” signifies an opening of the parallax barrier 12 which is open at a position corresponding to the position of the sub pixel 1-4. For example, in FIG. 4B, the representation “opening 1-1” indicates that the opening is positioned at the first position from the left at the first position from above of the parallax barrier 12 and exists at the position at which the sub pixel 1-1 is positioned.

Such a representation as described above is applied similarly also to other figures. It is to be noted that an opening of the parallax barrier 12 is sometimes provided so as to span two sub pixels, and in such a case, not the representation described above but a suitable reference character is used to denote the opening.

In the pixel disposition shown in FIG. 4A, one pixel is configured from four sub pixels disposed in a 2×2 matrix. For example, one pixel is configured from a sub pixel R of the sub pixel 1-1, a sub pixel G of the sub pixel 2-1, a sub pixel W of the sub pixel 1-2 and a sub pixel B of the sub pixel 2-2. Pixels each configured from a combination of such four sub pixels are disposed successively in both of the vertical direction and the horizontal direction to configure the display section 11.

FIG. 4B shows an example of the parallax barrier 12. Referring to FIG. 4B, the parallax barrier 12 has openings of a linear shape. Each opening formed in a linear shape is referred to as slit. A slit 101 of the parallax barrier 12 shown in FIG. 4B is provided in a vertical direction at a position at which it spans the sub pixel 1-1 and the sub pixel 2-1. The width of the slit 101 corresponds to the width of one sub pixel. Another slit 102 is provided in the vertical direction with a width equal to that of the slit 101 at a position at which it spans the sub pixel 5-1 and the sub pixel 6-1.

The display apparatus 10 is configured by overlapping the parallax barrier 12 shown in FIG. 4B on the display section 11 having the disposition of sub pixels illustrated in FIG. 4A. The overlapping state of the parallax barrier 12 and the display section 11 in the overlapped state is illustrated in FIG. 4C. Referring to FIG. 4C, one half of the sub pixel R of the sub pixel 1-1, one half of the sub pixel G of the sub pixel 2-1, one half, of the sub pixel B of the sub pixel 2-2 and one half of the sub pixel W of the sub pixel 1-2 can be seen through the slit 101. In this manner, one half of each of four sub pixels which configure one pixel can be seen through the slit 101.

Also the other slit is configured similarly such that sub pixels disposed in a pixel can be seen at one half thereof through the opening thereof. In this manner, each slit is configured such that a combination of four sub pixels which configure one pixel can be seen therethrough.

When a 2D image is to be provided to a viewer, since an image is provided in such a disposition of pixels as shown in FIG. 4A, an image of high picture quality can be provided. On the other hand, when a 3D image is to be provided to a viewer, since an image is provided in such a form that all of four sub pixels which configure one pixel can be seen through a slit, an image of high picture quality can be provided.

However, in the case of a 3D image, what can be seen, for example, through the slit 101 are one half of the sub pixel R of the sub pixel 1-1, one half of the sub pixel G of the sub pixel 2-1, one half of the sub pixel B of the sub pixel 2-2 and one half of the sub pixel W of the sub pixel 1-2. In the case where a 3D image is to be provided to one viewer, when the viewer views the 3D image from an appropriate position, a good 3D image can be provided. However, if the viewer views from a position displaced a little from the appropriate position, then there is the possibility that an appropriate image cannot be provided in that the image looks in a different color caused by the displacement.

It is to be noted that, since, in the present specification, description is given taking a case in which a 3D image is provided to one viewer as an example as described hereinabove, the term “views from an appropriate position” signifies that the viewer can view within a range within which, for example, the color difference of the image is permissible. Therefore, the significance of “views from an appropriate position” sometimes differs in a case in which a plurality of different screen images are provided to different viewers, namely, in provision of multi-screen images, another case in which a stereoscopic image is provided to a plurality of viewers, namely in provision of images from multi-viewpoints or a like case. However, the appropriate position generally is a viewing position at which an image or images provided to a viewer or viewers are not broken and the color remains within a permissible range.

For example, if a viewer is displaced from an appropriate position, then there is the possibility that only the sub pixel R of the sub pixel 1-1 and the sub pixel W of the sub pixel 1-2 can be seen through the slit 101 while the sub pixel G of the sub pixel 2-1 and the sub pixel B of the sub pixel 2-2 cannot be seen through the slit 101. If the pixel is seen in this manner, then it looks in a changed color. In this instance, the color from the sub pixel R of red is provided to the viewer. Therefore, an appropriate 3D image cannot be provided.

### First Disposition of the Pixels

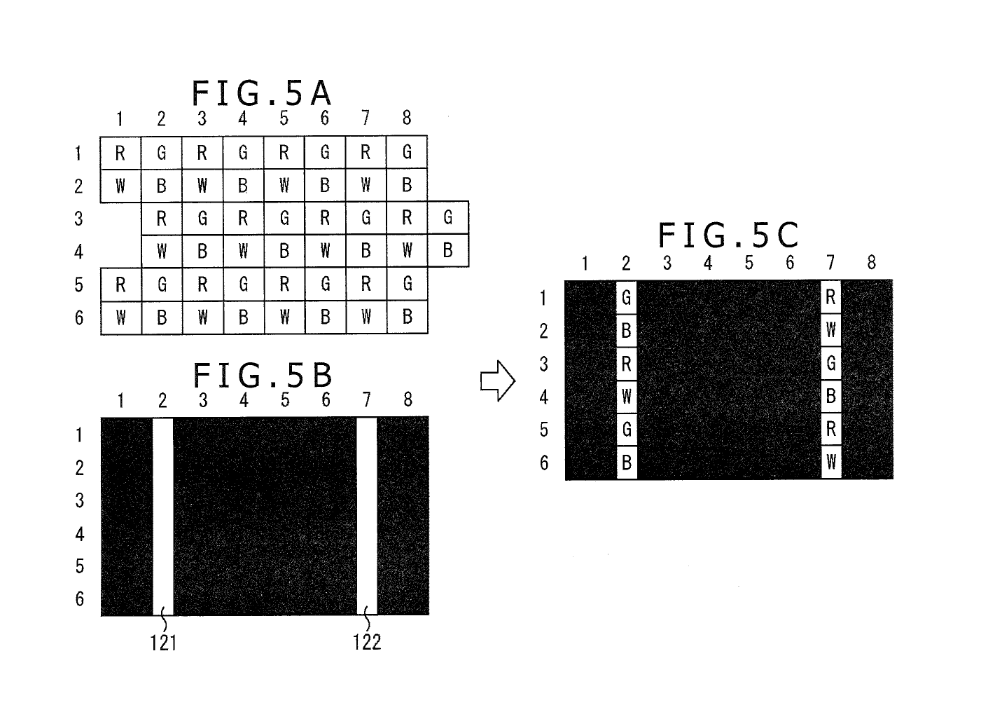

Therefore, the pixels are disposed in such a manner as illustrated in FIG. 5A. The disposition of pixels shown in FIG. 5A is described. The disposition of pixels illustrated in FIG. 5A is similar to the disposition of pixels illustrated in FIG. 4A in that one pixel is configured from four sub pixels arrayed in a 2×2 matrix. However, the disposition of pixels illustrated in FIG. 5A is different from the location of pixels illustrated in FIG. 4A in that the pixels are displaced in a horizontal direction.

For example, on the lower side of the pixel positioned at the left upper corner and configured from the sub pixel R of the sub pixel 1-1, the sub pixel G of the sub pixel 2-1, the sub pixel B of the sub pixel 2-2 and the sub pixel W of the sub pixel 1-2, pixels are disposed in a displaced relationship by one line. In particular, in the example shown in FIG. 5A, the sub pixel R of the sub pixel 1-3 is moved to the position of the sub pixel 2-3, and the sub pixel W of the sub pixel 1-3 is moved to the position of the sub pixel 2-4 similarly. In this manner, the pixels in the second row from above are disposed in a state in which they are successively displaced by one sub pixel to the right side.

It is to be noted that, while such a representation as “pixels are disposed in a displaced relationship by one line” is used, one pixel configured from 2×2 sub pixels may be physically displaced in a horizontal direction and also wiring lines and so forth may be displaced or laid in accordance with the displacement as shown FIG. 5A.

Or, the representation signifies that one pixel configured from 2×2 sub pixels is disposed at a position displaced virtually as shown in FIG. 5A. While, in the example shown in FIG. 5A, the sub pixel 1-3 and the sub pixel 1-4 are shown blank in order to intentionally represent that they are in a displaced state, a sub pixel G and a sub pixel B are disposed actually.

Further, if driving of the circuitry is taken into consideration, then to displace signal lines and/or gate lines in accordance with the displacement of pixels causes an optical loss and increases the burden on the circuit, and therefore, this is not preferable. Therefore, the display section 11 is designed such that only input signals are changed on such a disposition of sub pixels as shown in FIG. 5A.

Although the displacement of pixels includes also physical displacement in this manner, preferably this signifies that the disposition of sub pixels is not physically displaced from such a pixel disposition as shown in FIG. 4A to such a pixel disposition as shown in FIG. 5A but is a disposition with which pixels look as if they were displaced.

The pixel disposition shown in FIG. 5A is described further. Pixels positioned at the second position in the vertical direction are disposed, in the horizontal direction, at positions displaced by a distance of one half of a pixel width to the right side from pixels positioned at the first positions in the vertical direction. Pixels at the third position in the vertical direction are disposed at positions same as those of the pixels in the first positions in the vertical direction. Although pixels positioned at the fourth positions in the vertical direction are not shown in FIG. 5A, they are disposed at the same positions in the horizontal direction as those of the pixels positioned at the second positions in the vertical direction.

In this manner, pixels disposed in odd-numbered rows and pixels in even-numbered rows are disposed in a state in which they are displaced by a distance of one half of a pixel width from each other. If such a parallax barrier 12 as shown in FIG. 5B is placed on the pixels of such a disposition as just described, then such pixels as shown in FIG. 5C can be seen through the slits.

It is to be noted that, although such a representation as “such pixels as shown in FIG. 5C can be seen through the slits” is used for the convenience of description, this signifies that, when the parallax barrier 12 shown in FIG. 5B is laminated on the display section 11 of the pixel disposition shown in FIG. 5A and is viewed from the front, the pixels can be seen through the slits. Therefore, for example, when a 3D image is to be provided, those sub pixels which can be seen through a slit 123 differ depending upon the viewing position of the viewer. In particular, for example, if the parallax barrier 12 is viewed from the front, then such sub pixels as shown in FIG. 5C can be seen, but if the parallax barrier 12 is viewed from a position other than the front, then neighboring sub pixels can be seen.

Further, in FIG. 5C, a state of sub pixels which can be seen from an appropriate position with one eye is illustrated. Although the representation of “can be seen through the slit” is used also in the following description, this has the same meaning as the state of FIG. 5C described above.

The parallax barrier 12 shown in FIG. 5B is configured such that each opening thereof is formed so as to be open continuously in the vertical direction similarly to the parallax barrier 12 shown in FIG. 4B. It is to be noted, however, that a slit 121 of the parallax barrier 12 shown in FIG. 5B is provided in the vertical direction beginning with the sub pixel 2-1. The slit 121 has a width equal to or smaller than the width of one sub pixel. Another slit 122 is provided in the vertical direction beginning with the sub pixel 7-1 and has a width equal to that of the slit 121.

The display apparatus 10 is configured by overlapping the parallax barrier 12 shown in FIG. 5B on the display section 11 having the disposition of sub pixels shown in FIG. 5A. The parallax barrier 12 and the display section 11 in the overlapping state are illustrated in FIG. 5C. Referring to FIG. 5C, the sub pixel G of the sub pixel 2-1, the sub pixel B of the sub pixel 2-2, the sub pixel R of the sub pixel 2-3 and the sub pixel W of the sub pixel 2-4 can be seen through the slit 121. In this manner, four sub pixels which configure one pixel can be seen through the slit 121.

Also any other slit is configured such that sub pixels disposed corresponding thereto can be seen through the opening thereof similarly. In this manner, the parallax barrier 12 is configured such that a set of four sub pixels which configure one pixel can be seen through each slit thereof.

When a 2D image is to be provided to the viewer, since an image is provided in such a disposition of pixels as shown in FIG. 5A, an image of high picture quality can be provided. On the other hand, when a 3D image is to be provided to the viewer, since the image is provided in such a form that all four sub pixels which configure one pixel can be seen through a slit, an image of high picture quality can be provided.

It is to be noted that, in the case of multi parallaxes, even if the viewing angle is changed, an image of a good picture quality can be provided. In particular, it is assumed that, when the image is viewed at a predetermined angle, for example, from the front, the columns 2 and 7 can be seen as shown in FIG. 5C. Then, the viewing angle may be changed such that the column 3, 4 or 5 can be seen or one third of the column 3 and two thirds of the column 4 can be seen. Also when the image which can be seen changes depending upon the angle in this manner, a good image of high picture quality in that the image is not colorized from any viewing position can be obtained.

On the other hand, in the case of a 3D image, what can be seen, for example, through the slit 101 are substantially all of the sub pixel R of the sub pixel 1-1, sub pixel G of the sub pixel 2-1, sub pixel G of the sub pixel 2-2 and sub pixel W of the sub pixel 1-2. Therefore, when the viewer views from a predetermined position such as the front, a good 3D image can be provided naturally. However, even if the viewer is displaced from the position, such a situation that the image is colorized and an appropriate image cannot be provided can be eliminated, and an image of good picture quality can be provided.

In the case where a 2D image is to be provided, one pixel is configured from the four colors of R, G, B and W configured from 2×2 sub pixels in the vertical and horizontal directions as shown in FIG. 5A. Meanwhile, in the case where a 3D image is to be provided, one pixel is configured from the four colors of R, G, B and W disposed in the vertical direction as shown in FIG. 5C. If, when a 3D image is to be provided, a parallax image is provided with one pixel formed from the colors of R, G, B and W in the slit direction in this manner, there is an effect also that a 3D image free from a sense of discomfort can be provided to a viewer.

### Different Shape 1 of the Parallax Barrier

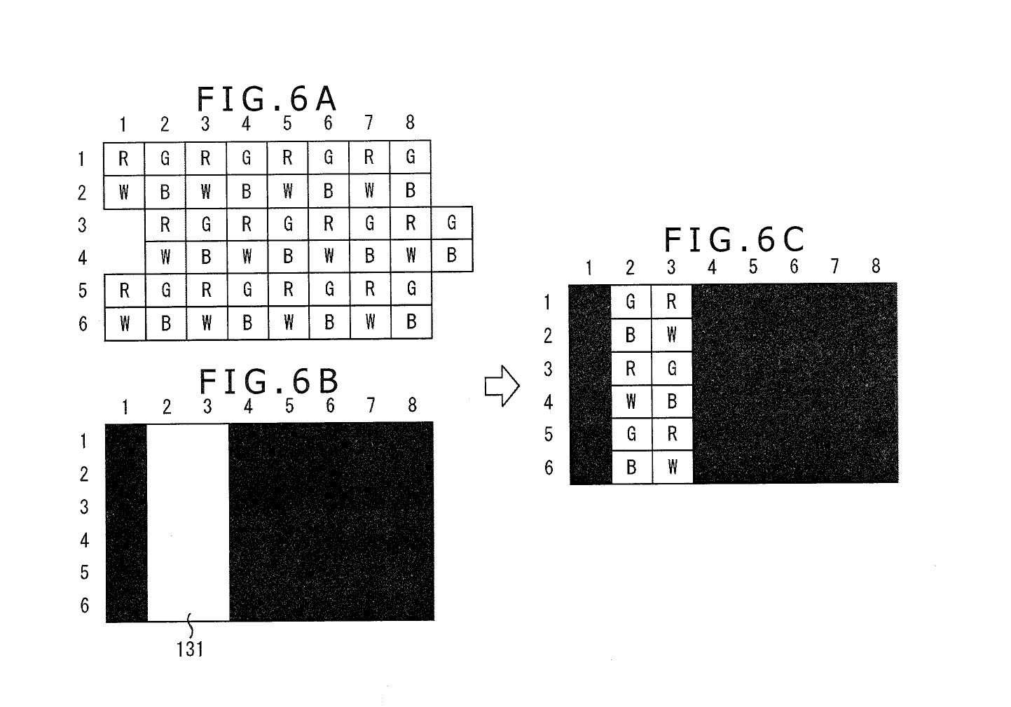

FIG. 6B shows a different shape of the parallax barrier 12. The disposition of pixels shown in FIG. 6A is same as the disposition of pixels shown in FIG. 5A. Particularly, in the disposition of pixels, pixels are disposed in a displaced relationship by a width of one sub pixel between adjacent rows similarly to the disposition of pixels shown in FIG. 5A. The parallax barrier 12 shown in FIG. 6B has a slit 131 open in the vertical direction.

The slit 131 of the parallax barrier 12 shown in FIG. 6B has a width equal to twice that of a sub pixel and is open in the vertical direction. In particular, in the example shown in FIG. 6B, the slit 131 has a width equal to that of two sub pixels including the sub pixel 2-1 and the sub pixel 3-1 and extends in the vertical direction from the top position which is the position of the two sub pixels.

If such a parallax barrier 12 as just described is overlapped with the display section 11 having the disposition of pixels shown in FIG. 6A, then the sub pixel G of the sub pixel 2-1, the sub pixel R of the sub pixel 3-1, the sub pixel B of the sub pixel 2-2 and the sub pixel W of the sub pixel 3-2 can be seen through the slit 131. In this manner, four sub pixels disposed in a 2×2 matrix and configuring one pixel can be seen through the slit 131.

Also any other slit is configured such that sub pixels disposed in a 2×2 matrix can be seen through the opening thereof similarly. In this instance, since the pixels are disposed in a displaced relationship for each row, pixels having the same disposition of sub pixels can be seen successively in the vertical direction. Therefore, also when a 3D image is to be provided to the viewer, the image is provided in such a form that all of four sub pixels which configure one pixel can be seen through a slit. Therefore, an image of high picture quality can be provided.

Further, similarly as in the case described hereinabove with reference to FIGS. 5A to 5C, when a viewer views from an appropriate position, a good 3D image can be provided naturally. However, even if the viewer views from a position displaced a little from the appropriate position, such a situation that the color of the image changes and an appropriate image cannot be provided can be eliminated.

### Different Shape 2 of the Parallax Barrier

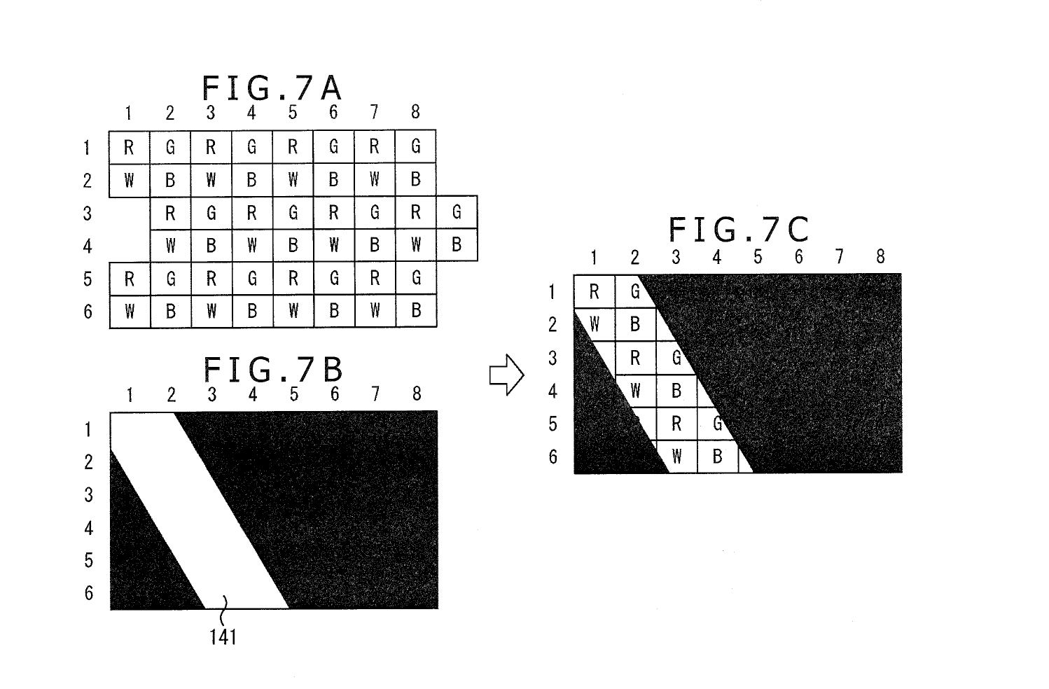

FIG. 7B shows another different shape of the parallax barrier 12. The disposition of pixels shown in FIG. 7A is same as the disposition of pixels shown in FIG. 5A. In particular, in the disposition of pixels, pixels are disposed in a displaced relationship from each other by a width of one sub pixel between adjacent rows similarly to the disposition of pixels shown in FIG. 5A. The parallax barrier 12 shown in FIG. 7B has a slit 141 open in an obliquely rightwardly downward direction.

The slit 141 of the parallax barrier 12 shown in FIG. 7B has a width equal to twice that of a sub pixel and is open obliquely toward a rightwardly downward direction. In particular, in the example shown in FIG. 7B, the slit 141 has a width equal to that of two sub pixels including the sub pixel 1-1 and the sub pixel 2-1 and extends in an oblique direction from the top position which is the position of the two sub pixels.

If such a parallax barrier 12 as just described is overlapped with the display section 11 having the disposition of pixels shown in FIG. 7A, then the sub pixel R of the sub pixel 1-1, the sub pixel G of the sub pixel 3-1, the sub pixel W of the sub pixel 1-2 and the sub pixel B of the sub pixel 2-2 can be seen through the slit 141. In this manner, four sub pixels disposed in a 2×2 matrix and configuring one pixel can be seen through the slit 141.

Also any other slit is configured such that sub pixels disposed in a 2×2 matrix can be seen through the opening thereof similarly. In this instance, since the pixels are disposed in a displaced relationship for each row, pixels having the same disposition of sub pixels can be seen successively in the oblique direction. Therefore, also when a 3D image is to be provided to the viewer, the image is provided in such a form that all of four sub pixels which configure one pixel can be seen through a slit. Therefore, an image of high picture quality can be provided.

Further, similarly as in the case described hereinabove with reference to FIGS. 5A to 5C, when the viewer views from an appropriate position, a good 3D image can be provided naturally. In addition, even if the viewer views from a position displaced a little from the appropriate position, such a situation that the color of the image changes and an appropriate image cannot be provided can be eliminated.

In FIGS. 5B, 6B and 7B, pixels each configured from a plurality of sub pixels of different colors from one another and disposed on the display section 11 and the parallax barrier 12 suitable for the disposition of the pixels and disposed in an opposing relationship to the display face side of the display section 11 are shown. Further, openings of the parallax barrier 12 which pass a light ray from the display section 11 therethrough toward a predetermined direction are shown.

As shown in FIGS. 5A, 6A and 7A, the disposition of pixels includes repetitions of all colors of the sub pixels in at least one of the horizontal direction and the vertical direction of the display section 11. Further, the sub pixels are disposed at positions at which the distances between adjacent sub pixels of the same colors are substantially equal to each other. In particular, for example, the sub pixel G of the sub pixel 2-1, sub pixel B of the sub pixel 2-2, sub pixel R of the sub pixel 2-3 and the sub pixel W of the sub pixel 2-4 disposed in the vertical direction configure one pixel.

If attention is paid to the sub pixel G of the sub pixel 2-1, then an adjacent sub pixel G is, for example, the sub pixel 4-1 or the sub pixel 3-3. Such a disposition as just described is similar also when attention is paid to the sub pixel R of the sub pixel 1-1. In this manner, in the disposition of pixels described above, the sub pixels are disposed at positions at which the distances between adjacent sub pixels of the same colors are substantially equal to each other.

In other words, according to the dispositions of pixels shown in FIGS. 5A, 6A and 7A, one pixel is configured from sub pixels of four colors disposed in a 2×2 matrix, and the sub pixels are disposed at positions displaced by a distance of one sub pixel for each row in a unit of a pixel.

Further, in other words, according to the dispositions of pixels shown in FIGS. 5A, 6A and 7A, repetitions of all colors, namely, of R, G, B and W, of sub pixels exist in the vertical direction of the display section 11, and the sub pixels are disposed at positions different between adjacent columns.

As a shape of each opening of the parallax barrier 12 suitable for such disposition of pixels, a shape of an opening which has a linear shape in the vertical direction and has a width substantially equal to that of a sub pixel as shown in FIG. 5B is applicable. Another shape of an opening which has a linear shape in the vertical direction and has a width substantially equal to an integral multiple, in FIG. 6B, twice, of that of a sub pixel as shown in FIG. 6B may be used. Or, a further shape of an opening which has a substantially linear shape in an oblique direction and has a width substantially equal to an integral multiple, in FIG. 7B, twice, of that of a sub pixel as shown in FIG. 7B may be used.

It is to be noted that it is possible to change an opening in the vertical direction into an opening in the horizontal direction by changing the disposition of pixels.

### Second Disposition of the Pixels

In the example of the dispositions of pixels shown in FIGS. 4A to 7A, sub pixels are disposed in a 2×2 matrix to configure one pixel. Now, an example wherein one pixel is configured from sub pixels juxtaposed in the vertical direction or the horizontal direction is described.

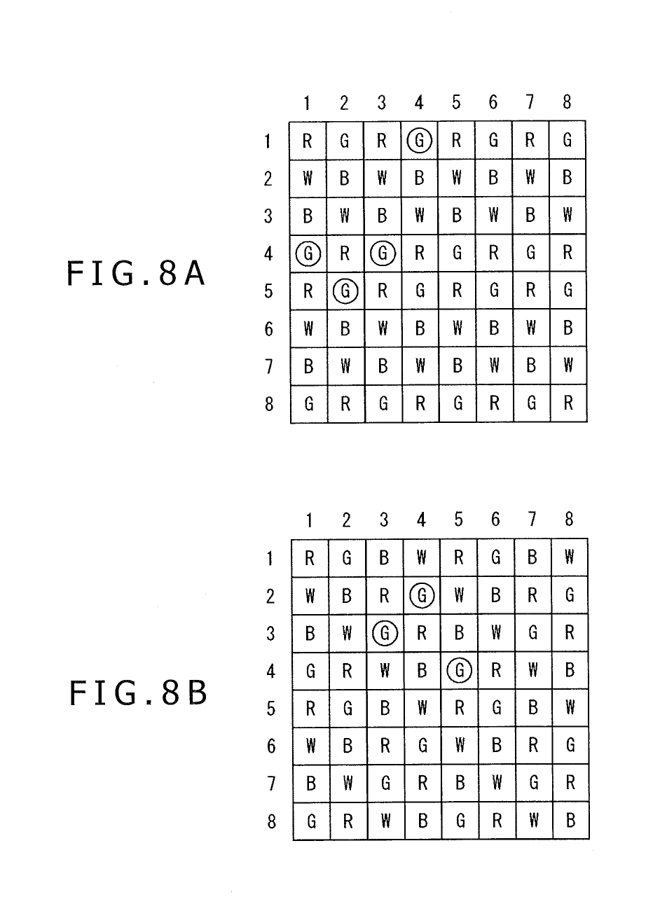

FIG. 8A shows an example of the display section 11 wherein one pixel is configured from four sub pixels disposed along the vertical direction. Referring to FIG. 8A, one pixel is configured, for example, from the sub pixel R of the sub pixel 1-1, sub pixel W of the sub pixel 1-2, sub pixel B of the sub pixel 1-3 and sub pixel G of the sub pixel 1-4. The disposition of colors differs among different columns, and in an adjacent column, the sub pixel G of the sub pixel 2-1, sub pixel B of the sub pixel 2-2, sub pixel W of the sub pixel 2-3 and sub pixel R of the sub pixel 2-4 are disposed in order.

In the disposition example of pixels shown in FIG. 8A, the sequence of sub pixels in the third column is same as that in the first column, and the sequence of sub pixels in the fourth column is same as that in the second column. In the disposition example, such dispositions of sub pixels are repeated.

Also FIG. 8B shows an example of the display section 11 wherein one pixel is configured from four sub pixels disposed along the vertical direction. Referring to FIG. 8B, one pixel is configured, for example, from the sub pixel R of the sub pixel 1-1, sub pixel W of the sub pixel 1-2, sub pixel B of the sub pixel 1-3 and sub pixel G of the sub pixel 1-4. The disposition of colors differs among different columns, and in an adjacent column, the sub pixel G of the sub pixel 2-1, sub pixel B of the sub pixel 2-2, sub pixel W of the sub pixel 2-3 and sub pixel R of the sub pixel 2-4 are disposed in order.

In the disposition example of pixels shown in FIG. 8B, in the third column, a sub pixel B, a sub pixel R, a sub pixel G and a sub pixel W are disposed in order from above, and in the fourth column, a sub pixel W, a sub pixel G, a sub pixel R and a sub pixel B are disposed in order from above. In the disposition example, such dispositions of sub pixels are repeated.

According to the dispositions of pixels illustrated in FIGS. 8A and 8B, for example, if such a parallax barrier 12 having a slit of a linear shape extending in the vertical direction as shown in FIG. 5B or 6B is used, a set of sub pixels which configure one pixel disposed in the vertical direction is included in the slit. Therefore, a 3D image of high picture quality can be provided to the viewer.

On the other hand, when a 2D image is to be provided to the viewer, since the dispositions of pixels shown in FIGS. 8A and 8B do not have colors distributed uniformly, there is the possibility that degradation of the picture quality may occur in that the screen image becomes rough or the like. For example, attention is paid to the sub pixel G of the sub pixel 3-4 in the disposition of pixels shown in FIG. 8A. It is assumed that one sub pixel has a square shape and the size of one side thereof is represented by a. Or, the distance between the center of a sub pixel and the center of another sub pixel adjacent the sub pixel is represented by a.

At this time, the distance between the sub pixel G of the sub pixel 3-4 and the center of the sub pixel G of the sub pixel 4-1 is √10a. Further, the distance between the sub pixel G of the sub pixel 3-4 and the sub pixel G of the sub pixel 2-5 both represented by a round mark in FIG. 8A is √2a. Further, the distance between the sub pixel G of the sub pixel 3-4 and the sub pixel G of the sub pixel 1-4 both represented by a round mark in FIG. 8A is 2a. In this manner, when attention is paid to one sub pixel G of green, the distances to other adjacent sub pixels G of green are different from each other.

Also with regard to any other pixel, the distances to adjacent pixels are much different from each other similarly. In this manner, the distance relationships between pixels of the same colors are much different from each other. In the case where the distance relationships among pixels are much different from each other in this manner, the image may possibly become rough.

Similarly, also in the disposition of pixels shown in FIG. 8B, the distance relationships among the pixels are much different from each other. For example, attention is paid to the sub pixel G of the sub pixel 3-3 in the disposition of pixels shown in FIG. 8B. At this time, the distance between the sub pixel G of the sub pixel 3-3 and the sub pixel G of the sub pixel 4-2 both represented by a round mark in FIG. 8B is √2a. Meanwhile, the distance between the sub pixel G of the sub pixel 3-3 and the sub pixel G of the sub pixel 5-4 both represented by a round mark in FIG. 8B is √5a. In this manner, when attention is paid to one sub pixel G of green, the distances to other adjacent sub pixels G are different from each other.

Also with regard to any other pixel, the distances to adjacent pixels are much different from each other similarly. In this manner, the distance relationships between pixels of the same colors are much different from each other. In the case where the distance relationships among pixels are much different from each other in this manner, the image may possibly become rough.

### Third Disposition of the Pixels

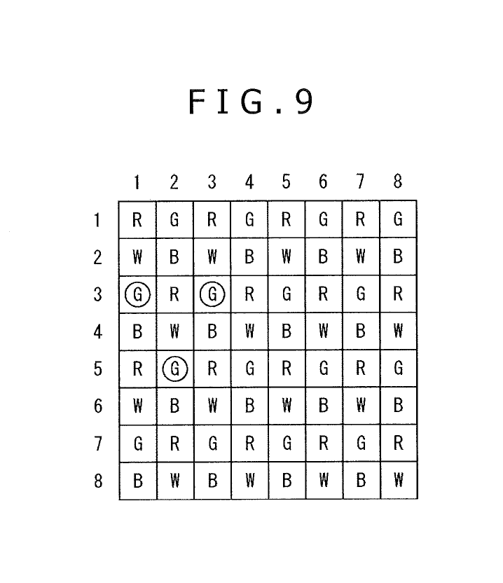

Therefore, pixels are disposed in such a manner as illustrated in FIG. 9. The disposition of pixels illustrated in FIG. 9 is described below. In the disposition of pixels illustrated in FIG. 9, one pixel is configured from four sub pixels in the vertical direction similarly to the disposition of pixels illustrated in FIG. 8A or 8B. However, the disposition of sub pixels is different from the disposition of pixels illustrated in FIG. 8A or 8B.

For example, one pixel is configured from the sub pixel R of the sub pixel 1-1, sub pixel W of the sub pixel 1-2, sub pixel B of the sub pixel 1-3 and the sub pixel G of the sub pixel 1-4. The color disposition differs between different columns, and in an adjacent column, the sub pixel G of the sub pixel 2-1, sub pixel B of the sub pixel 2-2, sub pixel R of the sub pixel 2-3 and sub pixel W of the sub pixel 2-4 are disposed in order.

In the disposition example of pixels illustrated in FIG. 9, the sequence of sub pixels in the third column is same as the sequence of sub pixels in the first column, and the sequence of sub pixels in the fourth column is same as the sequence of sub pixels in the second column. Such dispositions of sub pixels are repeated.

According to the disposition of pixels illustrated in FIG. 9, when such a parallax barrier 12 which has a slit of a linear shape in the vertical direction, for example, as shown in FIG. 5B or 6B is used, a set of sub pixels which are disposed in the vertical direction and configure one pixel is included in the slit. Therefore, a 3D image of high picture quality can be provided to the viewer.

Further, according to the disposition of pixels illustrated in FIG. 9, when such a parallax barrier 12 which has a slit of a linear shape in an oblique direction as shown, for example, in FIG. 7B is used, a set of sub pixels which are disposed in an oblique direction and configure one pixel is included in the slit. Therefore, also when the parallax barrier 12 having a slit in an oblique direction is used, a 3D image of high picture quality can be provided to the viewer.

Further, when a 2D image is to be provided to the viewer, since the disposition of pixels is different from those shown in FIGS. 8A and 8B, the colors are distributed uniformly. Therefore, the possibility that degradation of the picture quality may occur in that the screen image becomes rough or the like is low. Here, attention is paid to the sub pixel G of the sub pixel 3-3 in the disposition of pixels illustrated in FIG. 9. The reference character a used in the following description represents one side of one sub pixel when it is assumed that the sub pixel has a square shape or a distance of the pitch of the sub pixels similarly to the definition given hereinabove.

At this time, the distance between the sub pixel G of the sub pixel 3-3 and the sub pixel G of the sub pixel 2-1 both represented by a round mark is √5a. Further, the distance between the sub pixel G of the sub pixel 3-3 and the sub pixel G of the sub pixel 1-3 both represented by a round mark is 2a. Further, the distance between the sub pixel G of the sub pixel 3-3 and the sub pixel G of the sub pixel 2-5 both represented by a round mark is √5a. In this manner, when attention is paid to one sub pixel G of green, the distance to another sub pixel G of green adjacent the sub pixel G of green is √5a or 2a.

Also with regard to any other pixel, the distance to an adjacent pixel of the same color is √5a or 2a similarly. Since √5a is approximately 2.2a, the distance between adjacent pixels of the same color is substantially equal with regard to any sub pixel. In other words, according to the disposition of pixels illustrated in FIG. 9, the distance relationships of pixels between the same colors are same, and the possibility that the image may become rough is low.

Therefore, according to such a disposition of pixels as illustrated in FIG. 9, it is possible to allow the viewer to view both of a 2D image and a 3D image in a good picture quality state.

Further, according to such a disposition of pixels as illustrated in FIG. 9, also it is possible to increase the resolution to twice. Here, the disposition of pixels illustrated n FIG. 4A is referred to again and compared with the disposition of pixels illustrated in FIG. 9. In the disposition of pixels illustrated in FIG. 4A, a sub pixel R and a sub pixel W exist in the first, third and fifth columns, and a sub pixel G and a sub pixel B exist in the second, fourth and sixth columns.

In contrast, according to the disposition of pixels illustrated in FIG. 9, a sub pixel R, a sub pixel G, a sub pixel B and a sub pixel W are included in each column. Therefore, while, in the disposition of pixels illustrated in FIG. 4A, sub pixels of the same color can be represented only at every other sub pixel position, in the disposition of pixels illustrated in FIG. 9, sub pixels of the same color can be represented in all columns. From this, the resolution can be raised to twice.

In the disposition of pixels illustrated in FIG. 9, repetitions of all colors of sub pixels are included in at least one of the horizontal direction and the vertical direction of the display section 11, and sub pixels are disposed at such positions that the distances between adjacent sub pixels of the same colors are substantially equal to each other. In particular, for example, the sub pixel R of the sub pixel 1-1, sub pixel W of the sub pixel 1-2, sub pixel G of the sub pixel 1-3 and the sub pixel B of the sub pixel 1-4 disposed in the vertical direction configure one pixel.

Further, if attention is paid to the sub pixel G of the sub pixel 3-3, then an adjacent sub pixel G is, for example, the sub pixel 1-3 or the sub pixel 2-5, and the distance relationships to them are substantially equal to each other. This similarly applies also to pixels of the other colors. In short, in the disposition of sub pixels described above, sub pixels are disposed at such positions that the distances between adjacent pixels of the same colors are substantially equal to each other.

In other words, according to the disposition of pixels illustrated in FIG. 9, repetitions of all colors, namely, of R, G, B and W, exist in the vertical direction of the display section 11, and the disposition of the sub pixels differs between adjacent columns.

The opening of the parallax barrier 12 suitable for such disposition of pixels as described above may have such a shape as shown in FIG. 5B which has a linear shape in the vertical direction and has a width substantially equal to that of a sub pixel. Or, the shape of an opening of the parallax barrier 12 may be such as shown in FIG. 6B which has a linear shape in the vertical direction and has a width substantially equal to an integral multiple, twice in FIG. 6B, of the width of a sub pixel. Or else, the shape of an opening of the parallax barrier 12 may be such as shown in FIG. 7B which has a linear shape in an oblique direction and has a width substantially equal to an integral multiple, twice in FIG. 7B, of the width of a sub pixel.

It is to be noted that it is possible to change an opening in the vertical direction into an opening in the horizontal direction by changing the disposition of pixels.

### Fourth Disposition of the Pixels

In the dispositions of pixels described hereinabove with reference to FIGS. 4A to 9, the shape of sub pixels is a substantially square shape as an example as shown, for example, in FIG. 9. The shape of sub pixels is not limited to a square shape but may be a rectangular shape described below.

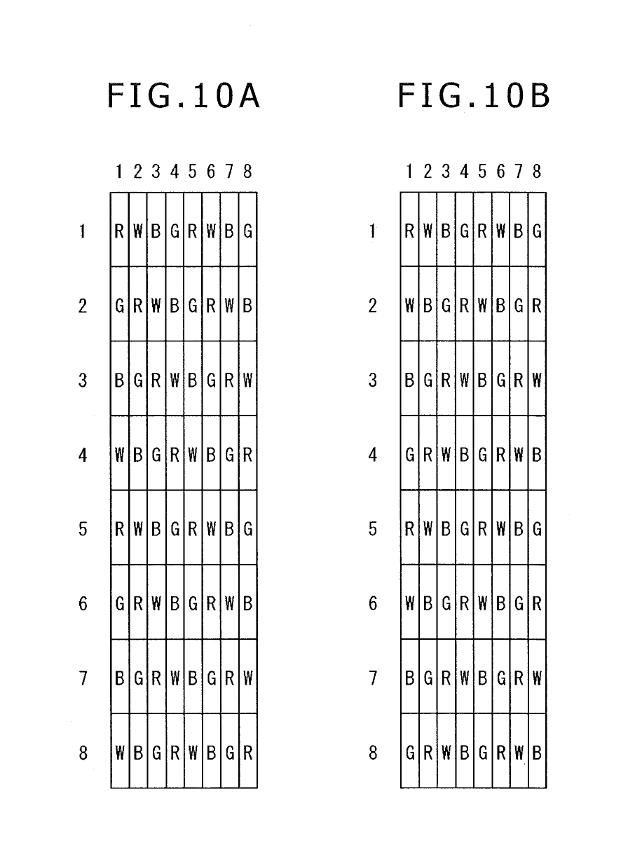

FIG. 10A illustrates a disposition of pixels when the shape of one sub pixel is a rectangle. FIG. 10A particularly shows an example of a disposition of pixels by which both of a 2D image and a 3D image can be provided in a good picture quality state to the viewer.

Referring to FIG. 10A, in the disposition of pixels illustrated, one pixel is configured from four sub pixels in the vertical direction. For example, one pixel is configured from the sub pixel R of the sub pixel 1-1, sub pixel G of the sub pixel 1-2, sub pixel B of the sub pixel 1-3 and sub pixel W of the sub pixel 1-4. The disposition of colors differs between different columns, and in an adjacent column, the sub pixel W of the sub pixel 2-1, sub pixel R of the sub pixel 2-2, sub pixel G of the sub pixel 2-3 and sub pixel B of the sub pixel 2-4 are disposed in order.

In the disposition example of pixels illustrated in FIG. 10A, a repetition of R, G, B and W is displaced one by one for each row. For example, if attention is paid to sub pixels R of red, then they are disposed successively in an obliquely rightwardly downward direction like the sub pixel 1-1, sub pixel 2-2, sub pixel 3-3, . . . . Also sub pixels of the other colors are disposed successively in an obliquely rightwardly downwardly.

In other words, according to such a disposition as described above, when the same color is viewed, the pixel looks to move downwardly one by one in the vertical direction. However, in the horizontal direction, if the first position is represented by a, then the pixel looks to move to a+1, a+2, a+3, . . . positions and such pixels are distributed equally at the four positions. Then, the pixel at the position a+3 is followed by the pixel at the position a.

Also FIG. 10B illustrates a disposition of pixels when the shape of one sub pixel is a rectangle. Also the disposition of pixels illustrated in FIG. 10B can provide both of a 2D image and a 3D image in a good picture quality state to the viewer.

In the disposition of pixels illustrated in FIG. 10B, one pixel is configured from four sub pixels in the vertical direction. For example, one pixel is configured from the sub pixel R of the sub pixel 1-1, sub pixel W of the sub pixel 1-2, sub pixel B of the sub pixel 1-3 and sub pixel G of the sub pixel 1-4. The disposition of the colors differs between different columns, and in an adjacent column, the sub pixel W of the sub pixel 2-1, sub pixel B of the sub pixel 2-2, sub pixel G of the sub pixel 2-3 and sub pixel R of the sub pixel 2-4 are disposed in order.

Also in the disposition example of pixels illustrated in FIG. 10B, a repetition of R, G, B and W is displaced one by one for each row similarly to the disposition example of pixels illustrated in FIG. 10A. However, the direction of the disposition is different. For example, if attention is paid to the sub pixels R of red, then they are disposed successively in an obliquely leftwardly downward direction like the sub pixel 5-1, sub pixel 4-2, sub pixel 3-3, . . . . Also the sub pixels of the other colors are disposed successively in an obliquely leftwardly downward direction.

In other words, according to such a disposition as described above, when the same color is viewed, the pixel looks to move downwardly one by one in the vertical direction. However, in the horizontal direction, if the first position is represented by a, then the pixel looks to move to the a−1, a−2, a−3, . . . positions, and such pixels are distributed equally at the four positions. Then, the pixel at the position a−3 is followed by the pixel at the position a.

According to the dispositions of pixels illustrated in FIGS. 10A and 10B, the sub pixels are not localized at any place but are distributed uniformly. Therefore, a 2D image of high picture quality in that it has no color deviation can be provided to the viewer. Further, according to the dispositions of pixels illustrated in FIGS. 10A and 10B, for example, when such a parallax barrier 12 which has a slit of a liner shape in the vertical direction as shown in FIG. 5B or 6B is used, a set of sub pixels which are disposed in the vertical direction and configure one pixel is included in the slit. Therefore, a 3D image of high picture quality can be provided to the viewer.

### Fifth Disposition of the Pixels

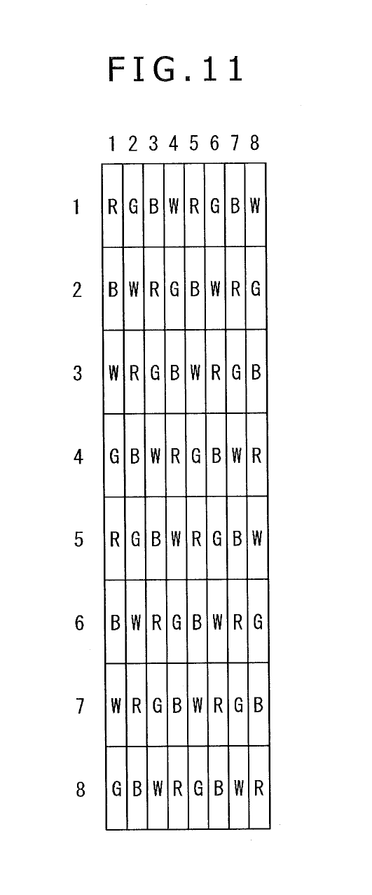

FIG. 11 illustrates a yet further disposition of pixels. In the disposition of pixels illustrated in FIG. 11, one pixel is configured from four sub pixels in the vertical direction. For example, one pixel is configured from the sub pixel R of the sub pixel 1-1, sub pixel B of the sub pixel 1-2, sub pixel W of the sub pixel 1-3 and sub pixel G of the sub pixel 1-4. The disposition of colors differs between different columns, and in an adjacent column, the sub pixel G of the sub pixel 2-1, sub pixel W of the sub pixel 2-2, sub pixel R of the sub pixel 2-3 and sub pixel B of the sub pixel 2-4 are disposed in order.

Paying attention to sub pixels of the same color, disposition of the sub pixels is described below. For example, if attention is paid to the sub pixel R of the sub pixel 1-1, then the sub pixels R are disposed like the sub pixel 1-1, sub pixel 3-2, sub pixel 2-3, sub pixel 4-4, sub pixel 5-1, . . . .

In other words, according to such a disposition as just described, if the same color is noticed, then in the vertical direction, the sub pixel looks to move one by one downwardly. Meanwhile, in the horizontal direction, if the initial position is represented by a (in this instance, since the pixel is at the position of the sub pixel 1-1, a=1), the sub pixel looks to move to the a+2, a+1 and a+3 positions. Thus, at the four positions, the sub pixels are disposed equally and regularly. Then, after the position a+3, the sub pixel looks to return to the position a. In this manner, the sub pixels are disposed in such a repetition as just described. Also the other sub pixels are disposed in accordance with a similar rule although they are different in the initial position.

In this instance, the disposition of sub pixels which configure one pixel differs depending upon the pixel and is not uniform. However, since the sub pixels are not localized very much but are disposed regularly, there is no color deviation. Therefore, a 2D image having high picture quality in that the color deviation is suppressed can be provided.

Further, according to the disposition of pixels illustrated in FIG. 11, when such a parallax barrier 12 which has a slit of a linear shape in the vertical direction as shown, for example, in FIG. 5B or 6B is used, a set of sub pixels which configure one pixel and are disposed in the vertical direction is included in the slit. Therefore, a 3D image of high picture quality can be provided to the viewer.

In the dispositions of pixels illustrated in FIGS. 10A, 10B and 11, repetitions of all colors of sub pixels are involved in at least one of the horizontal direction and the vertical direction of the display section 11, and sub pixels are disposed at positions at which the distances between adjacent sub pixels of the same colors are substantially equal to each other. In particular, the sub pixel R of the sub pixel 1-1, sub pixel G of the sub pixel 1-2, sub pixel B of the sub pixel 1-3 and sub pixel W of the sub pixel 1-4 disposed in the vertical direction configure one pixel.

In other words, in the dispositions of pixels illustrated in FIGS. 10A, 10B and 11, repetitions of all colors, namely, of R, G, B and W, of pixels are involved in the vertical direction of the display section 11, and the sub pixels are disposed such that the disposition differs between adjacent columns.

Further, in other words, in the dispositions of pixels illustrated in FIGS. 10A, 10B and 11, the sub pixels of the same color are disposed successively in the obliquely leftward direction or the obliquely rightward direction. For example, in the disposition of pixels illustrated in FIG. 10A, the sub pixels R are disposed successively in the obliquely rightwardly downward direction from the sub pixel 1-1 to the sub pixel 8-8. Also the sub pixels of the other colors are disposed successively in the obliquely rightwardly downward direction similarly.

As a shape of an opening of the parallax barrier 12 which is suitable for such a disposition of pixels as described above, a shape of an opening which is a linear shape in the vertical direction and has a width substantially equal to the wide of a sub pixel shown in FIG. 5B is applicable. Or, a shape of an opening which is a linear shape in the vertical direction and has a width substantially equal to an integral multiple of the width of a sub pixel shown in FIG. 6B, twice in FIG. 6B may be applied.

It is to be noted that it is possible to change an opening in the vertical direction into an opening in the horizontal direction by changing the disposition of pixels.

### Sixth Disposition of the Pixels

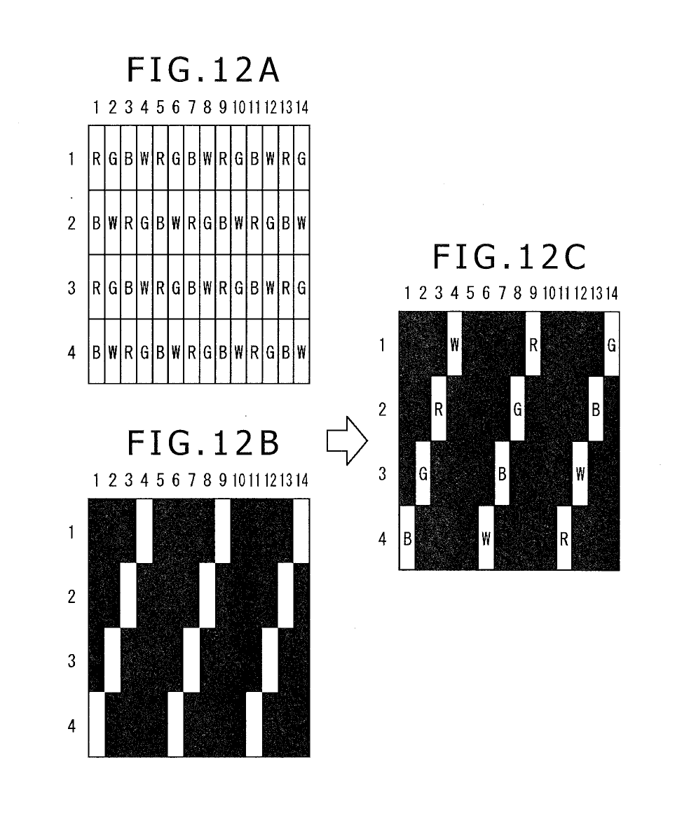

FIG. 12A illustrates a still further disposition of pixels. In the pixel disposition illustrated in FIG. 12A, one pixel is configured from four sub pixels disposed in a 2×2 matrix. For example, one pixel is configured from the sub pixel R of the sub pixel 1-1, sub pixel G of the sub pixel 2-1, sub pixel B of the sub pixel 2-2 and sub pixel W of the sub pixel 1-2. This pixel is referred to as pixel M.

Another pixel N which is positioned adjacent the pixel M in the horizontal direction is configured from the following sub pixels. In particular, the pixel N is configured from the sub pixel B of the sub pixel 3-1, sub pixel W of the sub pixel 4-1, sub pixel G of the sub pixel 4-2 and sub pixel G of the sub pixel 3-2. Further, a further pixel O which is positioned adjacent the pixel N in the horizontal direction has a disposition of sub pixels same as that of the pixel M. In this manner, in the horizontal direction, a pixel having the same disposition of sub pixels is disposed repetitively at every other pixel position.

Further, a pixel disposed on the lower side of the pixel M has a disposition of sub pixels same as that of the pixel M, and a pixel disposed on the lower side of the pixel N has a disposition of sub pixels same as that of the pixel N. In this manner, in the vertical direction, a pixel having a same disposition of sub pixels is disposed successively.

In the case of such dispositions of pixels as described above, the sub pixels are disposed in such regularity as described above, and R, G and B are distributed equally and the positional relationships of the colors are kept uniform. Therefore, a 2D image of high picture quality can be provided to the viewer. However, for example, if such a parallax barrier 12 which has a slit in the vertical direction having a width equal to the width of one sub pixel as shown in FIG. 5A is used to provide a 3D image, there is the possibility that the 3D image is degraded in picture quality.

In particular, if the disposition of pixels shown in FIG. 12A is viewed in the vertical direction, then a column in which only sub pixels R and sub pixels B exist and another column in which only sub pixels G and sub pixels W exist are disposed alternately. According to the disposition, a column in which only sub pixels R and sub pixels B exist or another column in which only sub pixels G and sub pixels W exist is included in one linear slit. Therefore, four sub pixels which configure one pixel do not exist in one slit, and there is the possibility that the picture quality of a 3D image may be degraded.

Therefore, such a parallax barrier 12 which has a stepped slit as shown in FIG. 12B is used. The size of one opening of the parallax barrier 12 shown in FIG. 12B is configured substantially equal to the size of one sub pixel. Further, each slit is shaped such that openings are provided along a direction from the upper right to the lower left.

For example, the opening 3-2 is provided on the lower left of the opening 4-1, and the opening 2-3 is provided on the lower left of the opening 3-2. Further, the opening 1-4 is provided on the lower left of the opening 2-3. In this manner, the openings are provided in a stepped disposition.

It is to be noted that, although the parallax barrier 12 wherein rectangles each having a size corresponding to a sub pixel are provided stepwise successively in an oblique direction as shown in FIG. 12B, they may not be disposed stepwise but may be formed as a slit of a linear shape extending in an oblique direction.

In the display apparatus 10, the parallax barrier 12 shown in FIG. 12B is overlapped on the pixels shown in FIG. 12A. The parallax barrier 12 and the pixels in the overlapped state are shown in FIG. 12C. Referring to FIG. 12C, the sub pixel W of the sub pixel 4-1 can be seen through the opening 4-1 which configures one slit of the parallax barrier 12; the sub pixel R of the sub pixel 3-2 can be seen through the opening 3-2; the sub pixel G of the sub pixel 2-3 can be seen through the opening 2-3; and the sub pixel B of the sub pixel 1-4 can be seen through the opening 1-4. Also through the other openings, the sub pixels disposed correspondingly can be seen similarly.

When viewed from one predetermined viewpoint, light from such sub pixels as shown in FIG. 12C is provided to the viewer. In this manner, in the parallax barrier 12 shown in FIG. 12B, the openings, namely, the slits, are provided so that sub pixels which configure one pixel such as sub pixels R, G, B and W became uniformized in an oblique direction in order to establish color balance of images of different parallaxes. Therefore, such degradation of the picture quality as arises from the fact that four sub pixels which configure one pixel as described above do not exist in one slit can be prevented.

### Different Shape of the Parallax Barrier

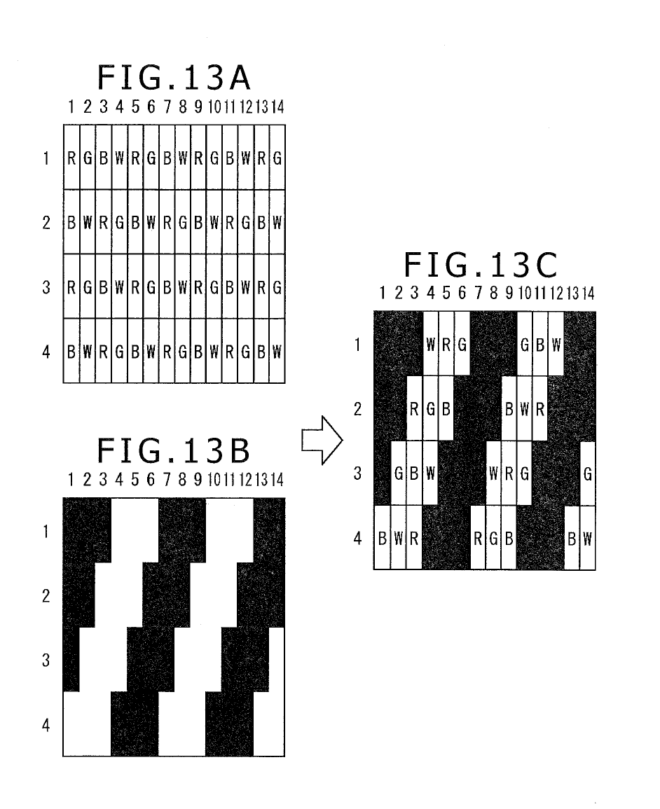

Now, the parallax barrier 12 of a different shape with which the picture quality when a 3D image is provided is not degraded with a disposition of sub pixels same as that of FIG. 12A is described with reference to FIG. 13.

The disposition of sub pixels illustrated in FIG. 13A is similar to that of sub pixels illustrated in FIG. 12A. If the parallax barrier 12 shown in FIG. 13B is provided on the display section 11 configured from sub pixels of such a configuration as just described, then light from such sub pixels as shown in FIG. 13C is provided to the viewer.

The parallax barrier 12 shown in FIG. 13B is described. Referring to FIG. 13B, the parallax barrier 12 shown has a shape same as that of the parallax barrier 12 shown in FIG. 12B and has slits having openings disposed successively in an obliquely leftwardly downward direction. However, the parallax barrier 12 of FIG. 13B is different from the parallax barrier 12 of FIG. 12B in that the width of the slits is greater.

In particular, in the parallax barrier 12 shown in FIG. 13B, beginning with an opening of a size which includes three sub pixels in the openings 4-1 to 6-1, openings of an equal width are provided successively in a leftwardly downward direction. In particular, if part of the parallax barrier 12 is exemplified, a slit configured from an opening A, another opening B, a further opening C and a still further opening D is provided in the parallax barrier 12 shown in FIG. 13B. The opening A is configured from the openings 4-1 to 6-1. The sub pixel B is configured from the openings 3-2 to 5-2 and provided on the left lower side of the opening A. The opening C is configured from the openings 2-3 to 4-3 and provided on the left lower side of the opening B. The opening D is configured from the openings 1-4 to 3-4 and provided on the left lower side of the opening C.

The parallax barrier 12 shown in FIG. 13B is overlapped with the pixels of the display apparatus 10 shown in FIG. 13A. The display apparatus 10 and the parallax barrier 12 in the overlapping state are shown in FIG. 13C. Referring to FIG. 13C, the sub pixel W, sub pixel R and sub pixel G of the openings 4-1 to 6-1 can be seen through the openings 4-1 to 6-1 which configure one slit of the parallax barrier 12, namely, through the opening A.

Similarly, the sub pixel R, sub pixel G and sub pixel B of the openings 3-2 to 5-2 can be seen through the openings 3-2 to 5-2 which configure one slit of the parallax barrier 12, namely, through the opening B. Further, through the opening C, the sub pixel G, sub pixel B and sub pixel W of the sub pixels 2-3 to 4-3 can be seen, and through the opening D, the sub pixel B, sub pixel W and sub pixel R of the sub pixels 1-4 to 4-4 can be seen. Also through the other openings, the sub pixels disposed correspondingly can be seen.

When the display apparatus 10 is viewed from a predetermined viewpoint, light from such sub pixels as shown in FIG. 13C is provided to the viewer. In this manner, also in the parallax barrier 12 shown in FIG. 13B, the openings, namely, the slits, are provided such that sub pixels which configure one pixel such as the sub pixels R, G, B and W become uniformized in an oblique direction in order to establish color balance of images of different parallaxes.

For example, the sub pixel R of the sub pixel 5-1, sub pixel G of the sub pixel 4-2, sub pixel B of the sub pixel 3-3 and sub pixel W of the sub pixel 2-4 are disposed in an oblique direction in one slit, and the colors of the sub pixels configure one pixel.

If sub pixels provided on the left side of the four sub pixels disposed in this manner in FIG. 13C are described similarly, then the sub pixel W of the sub pixel 4-1, sub pixel R of the sub pixel 3-2, sub pixel G of the sub pixel 2-3 and sub pixel B of the sub pixel 1-4 are disposed in an oblique direction within one slit. The colors of the sub pixels configure one pixel. Also on the right side, sub pixels of the four colors which configure one pixel are disposed in an oblique direction within one slit.

Since all of sub pixels of the four colors which configure one pixel are disposed uniformly in each slit in this manner, such degradation of the picture quality as arises from the fact that four sub pixels which configure one pixel as described above do not exist in one slit can be prevented.

In the dispositions of pixels illustrated in FIGS. 12 and 13, repetitions of all colors of sub pixels are involved at least in one of the horizontal direction and the vertical direction of the display section 11, and the sub pixels are disposed at positions at which the distances between adjacent sub pixels of the same colors are substantially equal to each other. In particular, for example, the sub pixel R of the sub pixel 1-1, sub pixel G of the sub pixel 2-1, sub pixel B of the sub pixel 3-1 and sub pixel W of the sub pixel 4-1 which are disposed in the horizontal direction configure one pixel.

In other words, according to the dispositions of pixels illustrated in FIGS. 12 and 13, all of the colors, namely, of R, G, B and W, of sub pixels are involved in the horizontal direction of the display section 11, and the sub pixels are disposed such that the disposition differs between adjacent columns.

Further in other words, according to the dispositions illustrated in FIGS. 12 and 13, one pixel is configured from four sub pixels of different colors disposed in a 2×2 matrix, and as pixels, a first pixel and a second pixel in which the disposition of colors of sub pixels is different are provided. For example, in FIG. 12A, the first pixel may be configured from the sub pixel R of the sub pixel 1-1, sub pixel G of the sub pixel 2-1, sub pixel B of the sub pixel 2-2 and sub pixel W of the sub pixel 1-2.

Meanwhile, the second pixel may be configured from the sub pixel B of the sub pixel 3-1, sub pixel W of the sub pixel 4-1, sub pixel G of the sub pixel 4-2 and sub pixel G of the sub pixel 3-2. The first and second pixels are disposed in the vertical direction and disposed alternately in the horizontal direction.

Where such a disposition as just described is applied, also it can be considered that sub pixels which configure one pixel are disposed successively in an obliquely leftward direction or an obliquely rightward direction. In particular, in FIG. 12A, the sub pixel R of the sub pixel 1-1, sub pixel W of the sub pixel 2-2, sub pixel B of the sub pixel 3-3 and sub pixel G of the sub pixel 4-4 configure one pixel.

In other words, in this instance, the sub pixels disposed successively in an obliquely rightward direction configure one pixel. By providing the openings of the parallax barrier 12 for such one pixel as just described, an image can be provided to the viewer without degradation of the picture quality through the parallax barrier 12. In other words, if the openings of the parallax barrier 12 are disposed in a stepped form and one opening is sized so as to be equal to the size of one or a plurality of sub pixels as illustrated in FIG. 12B or 13B, then a good three-dimensional image can be provided to the viewer.

### Seventh Disposition of the Pixels

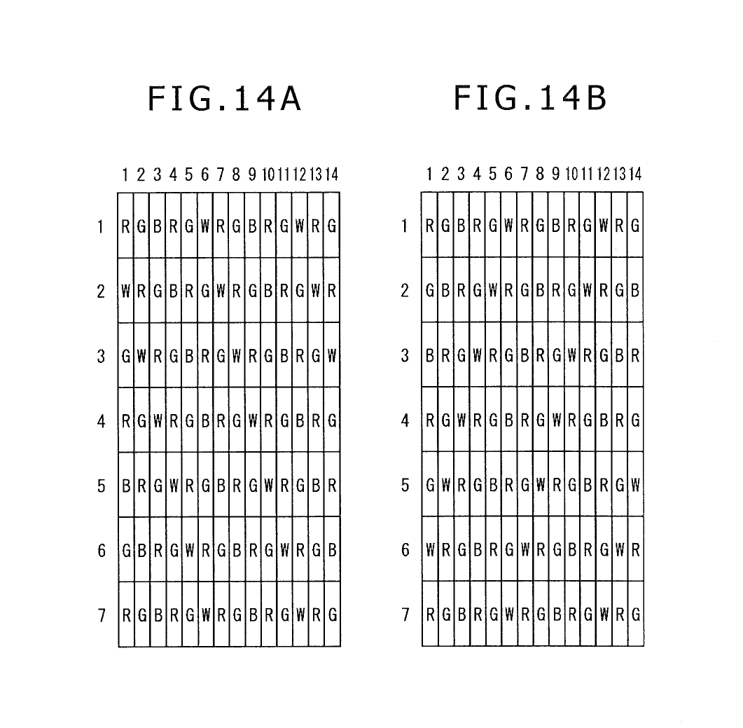

FIGS. 14A and 14B illustrate yet further dispositions of pixels. In the pixel dispositions illustrated in FIGS. 14A and 14B, while four sub pixels of different colors including a sub pixel R, another sub pixel G, a further sub pixel B and a still further sub pixel W are used, one pixel is configured from three colors and pixels of two different configurations are involved.

The dispositions of pixels illustrated in FIG. 14A include a first pixel configured from a sub pixel R, a sub pixel G and a sub pixel B and a second pixel configured from a sub pixel R, a sub pixel G and a sub pixel W. The first pixel is configured, for example, from the sub pixel R of the sub pixel 1-1, sub pixel G of the sub pixel 2-1 and sub pixel B of the sub pixel 3-1. The second pixel is configured, for example, from the sub pixel R of the sub pixel 4-1, sub pixel G of the sub pixel 5-1 and sub pixel W of the sub pixel 6-1.

The exemplified first and second pixels are disposed adjacent each other in the horizontal direction. In particular, in the example illustrated in FIG. 14A, the first and second pixels are disposed alternately in the horizontal direction.

In the vertical direction, another second pixel is disposed on the lower side of the first pixel exemplified in the foregoing description. In particular, the sub pixel W of the sub pixel 1-2, sub pixel R of the sub pixel 2-2 and sub pixel G of the sub pixel 3-2 which configure the second pixel are disposed on the lower side of the first pixel exemplified in the foregoing description. On the lower side of this second pixel, another first pixel is disposed.

In the examples illustrated in FIG. 14A, also in the vertical direction, the first pixel and the second pixel are disposed alternately. In this manner, according to the disposition of pixels illustrated in FIG. 14A, two kinds of pixels configured from different sub pixel components from each other, namely, the first pixel and the second pixel, are disposed alternately in both of the vertical direction and the horizontal direction.

Further, if attention is paid to the sub pixels R in FIG. 14A, then they are provided successively in an obliquely rightwardly downward direction in FIG. 14A like, for example, the sub pixel 1-1, sub pixel 2-2, sub pixel 3-3, . . . . Also the sub pixels of the other colors are provided successively in an obliquely rightwardly downward direction similarly to the sub pixels R. In this manner, in the disposition of pixels illustrated in FIG. 14A, the sub pixels of the same color are provided successively in an obliquely rightwardly downward direction. However, the sub pixels of the same colors may be provided successively in an obliquely leftwardly downward direction as seen in FIG. 14B.

In the disposition of sub pixels illustrated in FIG. 14B, the first pixel and the second pixel are disposed alternately in both of the vertical direction and the horizontal direction similarly as in the dispositions of sub pixels illustrated in FIG. 14A. Further, when attention is paid to the sub pixels of the same colors as described above, the sub pixels of the same colors are provided successively in an obliquely leftwardly downward direction.

In the dispositions of sub pixels illustrated in FIGS. 14A and 14B, the first and second pixels are disposed regularly and uniformly. Therefore, a 2D image of high picture quality can be provided to the viewer. Further, in the dispositions of sub pixels illustrated in FIGS. 14A and 14B, a 3D image of a high picture quality can be provided to the viewer.

In the dispositions of sub pixels illustrated in FIGS. 14A and 14B, since the first and second pixels are disposed alternately also in the vertical direction, when a predetermined column is viewed, sub pixels which configure the first pixels and sub pixels which configure the second pixels are disposed.

For example, if the first column of FIG. 14A is referred to, then a sub pixel R, a sub pixel G and a sub pixel B which configure a first pixel are disposed at the positions of the sub pixel 1-4, sub pixel 1-6 and sub pixel 1-5 in the first column, respectively. Meanwhile, a sub pixel R, a sub pixel G and a sub pixel W which configure a second pixel are disposed at the positions of the sub pixel 1-1, sub pixel 1-3 and sub pixel 1-2, respectively.

Owing to such dispositions as described above, for example, when the parallax barrier 12 shown in FIG. 5B which has a slit provided linearly in the vertical direction is used, the first and second pixels can be disposed in the slit. Also when the parallax barrier 12 shown in FIG. 6B which has a slit which in turn has a width within which a plurality of sub pixels are included in the horizontal direction is used, the first and second pixels can be disposed in the slit. Therefore, a 3D image of high picture quality can be provided to the viewer.

In the dispositions of sub pixels illustrated in FIGS. 14A and 14B, sub pixels of the same colors are disposed successively in an obliquely leftward direction or an obliquely rightward direction. For example, in the dispositions of sub pixels illustrated in FIGS. 14A and 14B, the sub pixels R are disposed successively in an obliquely rightwardly downward direction from the sub pixel 1-1 to the sub pixel 7-7. Also the sub pixels of the other colors are disposed successively in an obliquely rightwardly downward direction similarly.

It is to be noted that it is possible to change an opening in the vertical direction into an opening in the horizontal direction by changing the disposition of pixels.

### Eighth Disposition of the Pixels

In such a case that the display section 11 is a liquid crystal display apparatus wherein liquid crystal material is sealed or in a like case, the display section 11 is configured such that a predetermined gap is kept between two substrates and liquid crystal material is sealed between the substrates. In order to keep the gap between the two substrates, a spacer is provided. A sub pixel at which a spacer exists and another sub pixel at which the pacer does not exist are different in optical characteristic.

Further, since the spacer generally disturbs the liquid crystal orientation therearound, leakage of light occurs upon black display and the contrast of the display section, in FIG. 1, of the display section 11, is degraded. Further, when force is applied to the display section, the spacer sometimes damages an opposing portion of the orientation film, which is located on the array side because usually the spacer is disposed on the color filter side, resulting in leakage of light. Such leakage of light by the spacer is prevented by blocking light to some degree around the spacer. Therefore, light is blocked within a range greater than the diameter of the spacer.

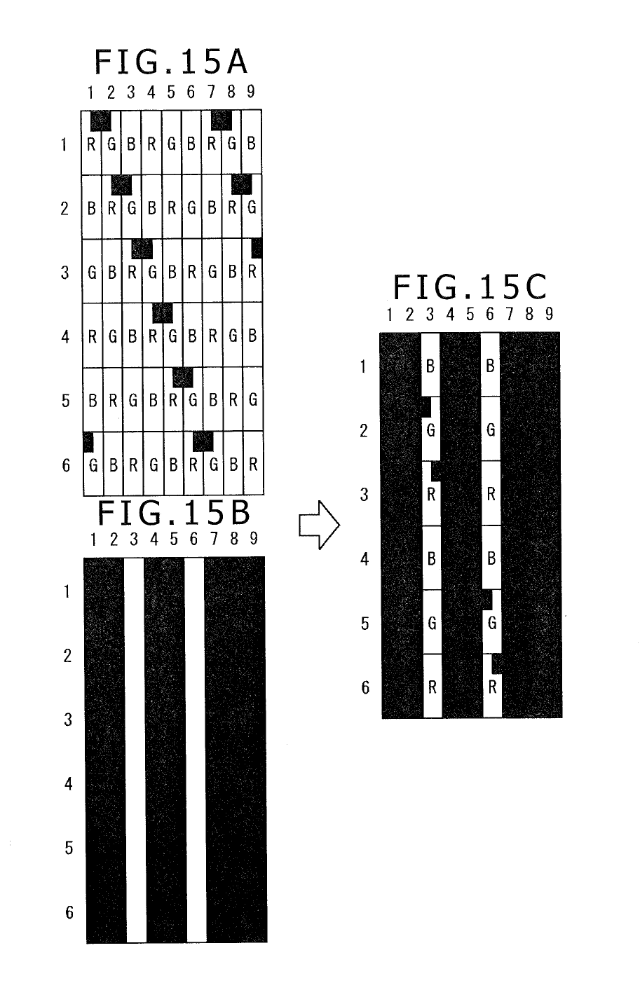

Therefore, also it is necessary to take the spacer into consideration. A relationship among a spacer, a pixel and a parallax barrier is described with reference to FIGS. 15A to 15C. It is to be noted that the description given with reference to FIGS. 15A to 15C is directed to an example wherein one pixel is configured from three sub pixels. In particular, one pixel is configured from three sub pixels including, for example, the sub pixel R of the sub pixel 1-1, sub pixel G of the sub pixel 2-1 and sub pixel B of the sub pixel 3-1 as shown in FIG. 15A. In sub pixels shown in FIG. 15A, sub pixels of the same colors are disposed in an obliquely rightwardly downward direction.

In FIG. 15A, a small dark quadrangle represents a spacer. It is to be noted that, while the shape of the spacer in FIG. 15 is represented by a quadrangle, the shape of the spacer is not limited to a quadrangle but may naturally be a polygon or a circle. In the example illustrated in FIG. 15A, a spacer is disposed on the upper side of a sub pixel R and a sub pixel G at a position at which it spans them. For example, a spacer is disposed at a position on the upper side of the sub pixel R of the sub pixel 1-1 and the sub pixel G of the sub pixel 2-1 at which it spans the sub pixel R and the sub pixel G. Since sub pixels of the same colors are disposed in an obliquely rightwardly downward direction, also spacers are disposed successively in the obliquely rightward downward direction.

Although the spacer exists on the sub pixel R of the sub pixel 1-1 and the sub pixel G of the sub pixel 2-1 exemplified as above, no spacer exists on the sub pixel R of the sub pixel 4-1 and the sub pixel G of the sub pixel 5-1. There is the possibility that a difference in luminance may occur between the sub pixel R of the sub pixel 1-1 on which the spacer exists and the sub pixel R of the sub pixel 4-1 on which the spacer does not exist. Similarly, there is the possibility that a difference in luminance may occur between the sub pixel G of the sub pixel 2-1 on which the spacer exists and the sub pixel G of the sub pixel 5-1 on which the spacer does not exist.

There is the possibility that a sub pixel may be partially shielded not only by the spacer but by adjustment of the degree of whiteness or a pattern of a circuit such as a transistor. The sub pixel shielded in this manner and another sub pixel which is not shielded have a difference in optical characteristic such as a difference in luminance.

If the parallax barrier 12 having the shape shown in FIG. 15B is provided on the display section 11 having such a disposition of pixels and a disposition of spacers as shown in FIG. 15A, then light from sub pixels is supplied to the viewer as seen in FIG. 15C. The parallax barrier 12 shown in FIG. 15B has slits of a linear shape.

Referring to FIG. 15C, the sub pixel B of the sub pixel 3-1 can be seen through the opening 3-1 of the parallax barrier 12; the sub pixel G of the sub pixel 3-2 through the opening 3-2; and the sub pixel R of the sub pixel 3-3 through the opening 3-3. The parallax barrier 12 is configured such that colors of sub pixels can be seen in this order. Thereafter, sub pixels of the three colors which configure one pixel are individually disposed equally and can be seen through the slit in this order. In this slit, the spacer exists on the sub pixel G of the sub pixel 3-2 and the sub pixel R of the sub pixel 3-3.

Further, the sub pixel B of the sub pixel 6-1 can be seen through the opening 6-1 of a slit which is positioned on the right side of the slit described above in FIG. 15C; the sub pixel G of the sub pixel 6-2 through the opening 6-2; and the sub pixel R of the sub pixel 6-3 through the opening 6-3. Thereafter, sub pixels of the three colors which configure one pixel are individually disposed equally and can be seen through the slit in this order. In this slit, the spacer exists on the sub pixel G of the sub pixel 6-5 and the sub pixel R of the sub pixel 6-6.

In this manner, in each slit, sub pixels which configure one pixel are disposed equally, and also sub pixels on which the spacer exists are disposed equally. Therefore, the optical characteristic of the sub pixels which can be seen through the slits can be made equal, and a 3D image of high picture quality can be provided to the viewer. Further, since the dispositions of the sub pixels and the spacers are uniform, also a 2D image can be provided in high picture quality to the viewer.

Further, it can be considered that, as a disposition relationship between the pixels and the spacers shown in FIGS. 15A to 15C, the spacers are disposed in a direction same as the direction in which the sub pixels of the same colors are disposed. For example, in FIG. 15A, the sub pixels R are disposed successively in an obliquely rightwardly downward direction which is a direction from the sub pixel 1-1 to the sub pixel 6-6, and also the spacers are disposed in the same direction as that of the disposition of the sub pixels R. By such dispositions of the pixels and the spacers as described above, also a 2D image can be provided in a high picture quality state to the viewer.

Further, in order to make it possible to provide also a 2D image in a high picture quality state to the viewer, such a parallax barrier as shown in FIG. 15B is used. In particular, the parallax barrier 12 has slits of a linear shape in which openings are provided such that the spacers are disposed equally at predetermined openings of the parallax barrier 12 therein and are disposed equally also in a relationship to the other openings. Also it is possible to configure the parallax barrier 12 in this manner.

### Ninth Disposition of the Pixels

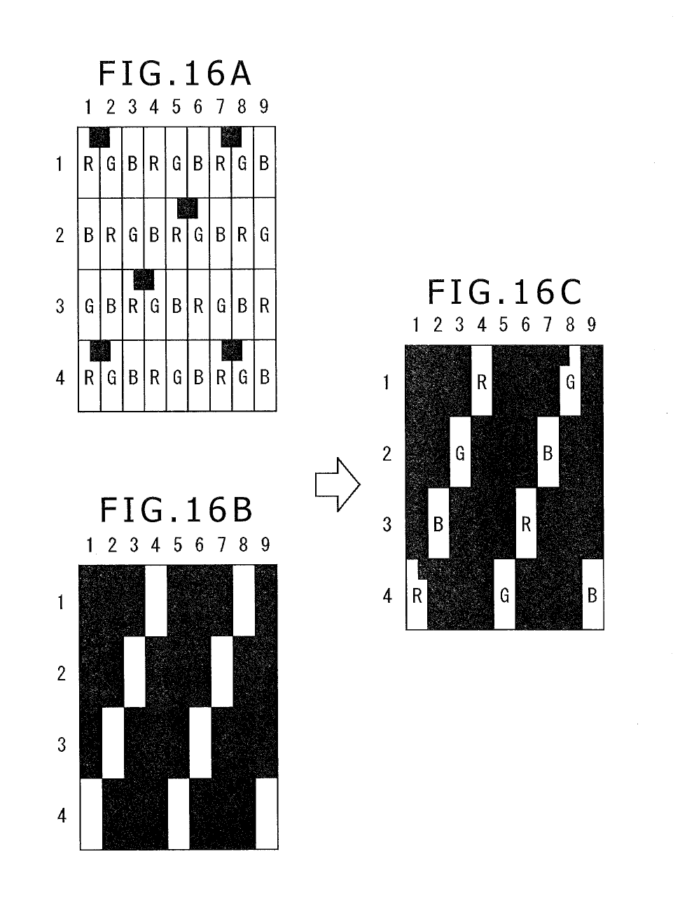

FIG. 16A illustrates another disposition of spacers. Although the disposition of pixels illustrated in FIG. 16A is same as the disposition of pixels illustrated in FIG. 15A, the positions of the spacers are different. In the disposition of sub pixels illustrated in FIG. 16A, a spacer is positioned at which it spans the sub pixel R of the sub pixel 1-1 and the sub pixel G of the sub pixel 2-1 and disposed on the upper side of the sub pixel R and the sub pixel G.

Similarly, the spacer is disposed at positions at which it spans the sub pixel R of the sub pixel 7-1 and the sub pixel G of the sub pixel 8-1, the sub pixel R of the sub pixel 5-2 and the sub pixel G of the sub pixel 6-2, the sub pixel R of the sub pixel 3-3 and the sub pixel G of the sub pixel 4-3, the sub pixel R of the sub pixel 1-4 and the sub pixel G of the sub pixel 2-4, and the sub pixel R of the sub pixel 7-4 and the sub pixel G of the sub pixel 8-4. The spacers are disposed on the upper side of the sub pixels mentioned.

If the parallax barrier 12 having the shape shown in FIG. 16B is provided on the display section 11 having such a disposition of pixels and a disposition of spacers as described above, then light from sub pixels is supplied to the viewer as seen in FIG. 16C. The parallax barrier 12 shown in FIG. 16B has slits of a stepped shape. The parallax barrier 12 shown in FIG. 16B has a shape same as that of the parallax barrier 12 shown in FIG. 12B.

Referring to FIG. 16C, the sub pixel R of the sub pixel 4-1 can be seen through the opening 4-1 which configures one slit of the parallax barrier 12; the sub pixel G of the sub pixel 3-2 through the opening 3-2; the sub pixel B of the sub pixel 2-3 through the opening 2-3; and the sub pixel R of the sub pixel 1-4 through the opening 1-4. In this slit, the spacer is disposed on the sub pixel R of the sub pixel 1-4.

Similarly, the sub pixel G of the sub pixel 8-1 can be seen through the opening 8-1 which configures one slit of the parallax barrier 12; the sub pixel B of the sub pixel 7-2 through the opening 7-2; the sub pixel R of the sub pixel 6-3 through the opening 6-3; and the sub pixel G of the sub pixel 5-4 through the opening 5-4. In this slit, the spacer is disposed on the sub pixel G of the sub pixel 8-1.

Also the other slits not shown are configured such that sub pixels corresponding thereto can be seen through the corresponding openings.

When the display apparatus 10 is viewed from a predetermined viewpoint, light from such sub pixels as shown in FIG. 16C is provided to the viewer. In this manner, in the parallax barrier 12 shown in FIG. 16B, the openings, namely, the slits, are provided so that sub pixels which configure one pixel such as sub pixels R, G, B and W become uniformized in an oblique direction in order to establish color balance of images of different parallaxes.

Further, since the sub pixels on which the spacer is disposed are disposed equally in the slits, the optical characteristics in the slits are uniform, and a 3D image of high picture quality can be provided to the viewer. Further, since the dispositions of the sub pixels and the spacers are uniform, also a 2D image can be provided in a high picture quality state to the viewer.

Further, it can be considered that, as a disposition relationship between the pixels and the spacers shown in FIGS. 16A to 16C, the spacers are disposed in a direction same as the direction in which the sub pixels of the same colors are disposed similarly to the disposition relationship between the pixels and the spacers illustrated in FIGS. 15A to 15C. For example, in FIG. 16A, the sub pixels R are disposed successively in an obliquely rightwardly downward direction which is a direction from the sub pixel 1-1 to the sub pixel 4-4, and also the spacers are disposed in a predetermined spaced relationship from each other in the same direction as that of the disposition of the sub pixels R. By such dispositions of the pixels and the spacers as described above, also a 2D image can be provided in a high picture quality state to the viewer.

Further, in order to make it possible to provide also a 2D image in a high picture quality state to the viewer, such a parallax barrier as shown in FIG. 16B is used. In particular, the parallax barrier 12 has slits of a stepped shape in which openings are provided such that the spacers are disposed equally at predetermined openings of the parallax barrier 12 and are disposed equally also in a relationship to the other openings. Also it is possible to configure the parallax barrier 12 in this manner.

### Tenth Disposition of the Pixels

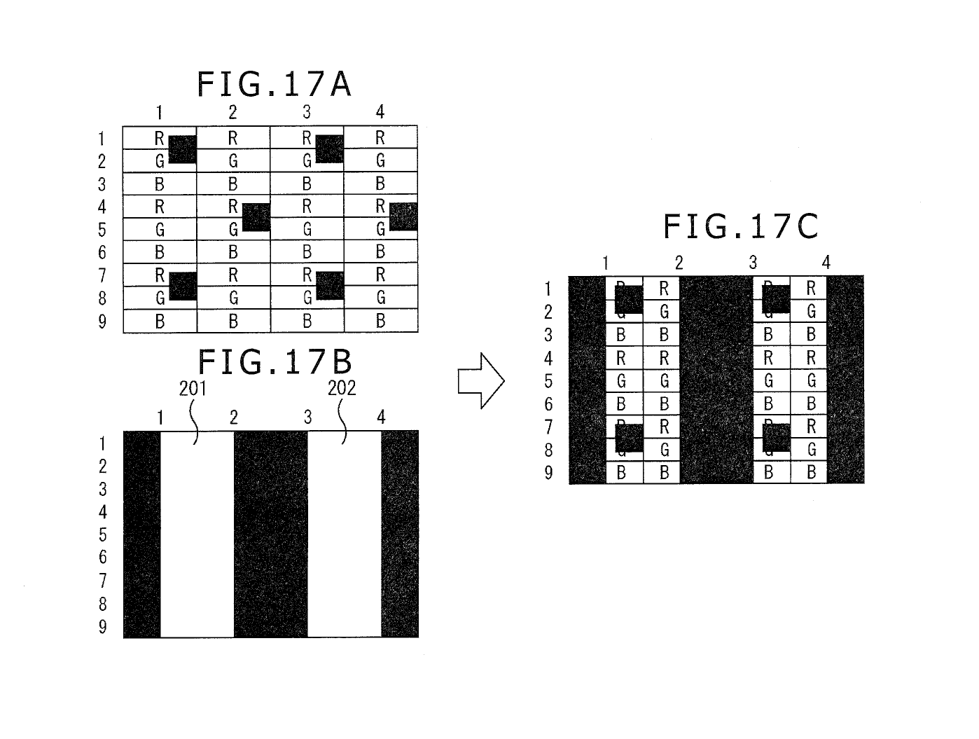

FIG. 15A or 16A exemplifies a case in which the sub pixels individually have a shape elongated in the vertical direction. The sub pixels can be configured also in another shape elongated in the horizontal direction, for example, as shown in FIG. 17A.

In the disposition of pixels illustrated in FIG. 17A, a sub pixel R, a sub pixel G and a sub pixel B which configure one pixel are disposed in the vertical direction. For example, one pixel is configured from the sub pixel R of the sub pixel 1-1, sub pixel G of the sub pixel 1-2 and sub pixel B of the sub pixel 1-3. Similarly, on the lower side of the pixel just described, one pixel is configured from the sub pixel R of the sub pixel 1-4, sub pixel G of the sub pixel 1-5 and sub pixel B of the sub pixel 1-6.

In the disposition of pixels illustrated in FIG. 17A, the spacer is disposed at a position at which it span the sub pixel R and the sub pixel G similarly as in the case shown in FIG. 16A and is disposed at a position displaced by a distance of one column. For example, a spacer is disposed at a right side position spanning the sub pixel R of the sub pixel 1-1 and the sub pixel G of the sub pixel 1-2.

A different spacer is disposed on a pixel positioned on the lower right side of the spacer. In particular, the spacer is disposed at a position spanning the sub pixel R of the sub pixel 2-4 and the sub pixel G of the sub pixel 2-5. Further, another different spacer is disposed also on both of a lower left pixel and a lower right pixel of the spacer. In this manner, the spacers are disposed alternately.

Where the parallax barrier 12 having a shape shown in FIG. 17B is provided on the display section 11 to which such disposition of the pixels and disposition of the spacers as described above are applied, light from the sub pixels is supplied to the viewer as seen in FIG. 17C. The parallax barrier 12 illustrated in FIG. 17B has a slit of a linear shape. The parallax barrier 12 shown in FIG. 17B has a shape same as that of the parallax barrier 12 shown in FIG. 6B.

The slit 201 of the parallax barrier 12 shown in FIG. 17B spans two sub pixels and has a width of one sub pixel, and is open in the vertical direction. In particular, in the example shown in FIG. 17B, the slit 201 is configured as a vertical slit which spans the two sub pixels including the sub pixel 1-1 and the sub pixel 2-1, has a width of one sub pixel and has a top thereof at the position of the two sub pixels. A slit 202 having the same shape as that of the slit 201 is provided on the right side of the slit 201 in FIG. 17B.

Where such a parallax barrier 12 as described above is overlapped on the display section 11 having the disposition of the pixels illustrated in FIG. 17A, one half of the sub pixel R of the sub pixel 1-1, one half of the sub pixel R of the sub pixel 2-1, one half of the sub pixel G of the sub pixel 1-2, one half of the sub pixel G of the sub pixel 2-2, one half of the sub pixel B of the sub pixel 1-3 and one half of the sub pixel B of the sub pixel 2-3 can be seen through the slit 201 as illustrated in FIG. 17C. In this manner, the sub pixels R, G and B which configure one pixel can be seen through the slit 201.

Further, the spacer is disposed on the sub pixel R of the sub pixel 1-1, sub pixel B of the sub pixel 1-2, sub pixel R of the sub pixel 1-7 and sub pixel G in the sub pixel 1-8 in the slit 201.

Similarly, one half of the sub pixel R of the sub pixel 3-1, one half of the sub pixel R of the sub pixel 4-1, one half of the sub pixel G of the sub pixel 3-2, one half of the sub pixel G of the sub pixel 4-2, one half of sub pixel B of the sub pixel 3-3 and one half of the sub pixel B of the sub pixel 4-3 can be seen through the slit 202. In this manner, the sub pixels R, G and B which configure one pixel can be seen also through the slit 202.

Further, the spacer is disposed on the sub pixel R of the sub pixel 3-1, sub pixel B of the sub pixel 4-2, sub pixel R of the sub pixel 3-7 and sub pixel G of the sub pixel 4-8 in the slit 202.

When viewed from one predetermined viewpoint, such light from the sub pixels as shown in FIG. 17C is provided to the viewer. In this manner, in the parallax barrier 12 shown in FIG. 17B, the openings, namely, the slits, are provided so that sub pixels which configure one pixel such as sub pixels R, G a d B become uniformized in the vertical direction in order to establish color balance of images of different parallaxes.

Further, since the sub pixels on which the spacers are disposed are uniformly disposed in each slit, the optical characteristics in the slits are uniformized to each other, and a 3D image having high picture quality can be provided to the viewer. Further, since the dispositions of the sub pixels and the spacers are uniformized, also a 2D image can be provided to the viewer in a high-picture quality state.

In the disposition of the pixels and the spacers shown in FIG. 17A, the spacers are disposed in a direction same as the direction in which the sub pixels having the same colors are disposed. In particular, for example, in FIG. 17A, the sub pixels R are disposed successively in the horizontal direction which is a direction from the sub pixel 1-1 to the sub pixel 1-4, and also the spacers are disposed in a predetermined spaced relationship in the same direction as that of the disposition of the sub pixels R. By such dispositions of the pixels and spacers as described above, also a 2D image can be provided to the viewer in a high-picture quality state as described above.

Further, in order to provide also a 2D image in a high-picture quality state to the viewer, such a parallax barrier as shown in FIG. 17B is used. In particular, the spacers are uniformly disposed in a predetermined opening of the parallax barrier 12 shown in FIG. 17B, and the parallax barrier 12 of a linear shape in which an opening is provided is configured such that the spacers are uniformly disposed therein also in a relationship with a different opening. The parallax barrier 12 can be configured in such a manner as described above.

### Eleventh Disposition of the Pixels

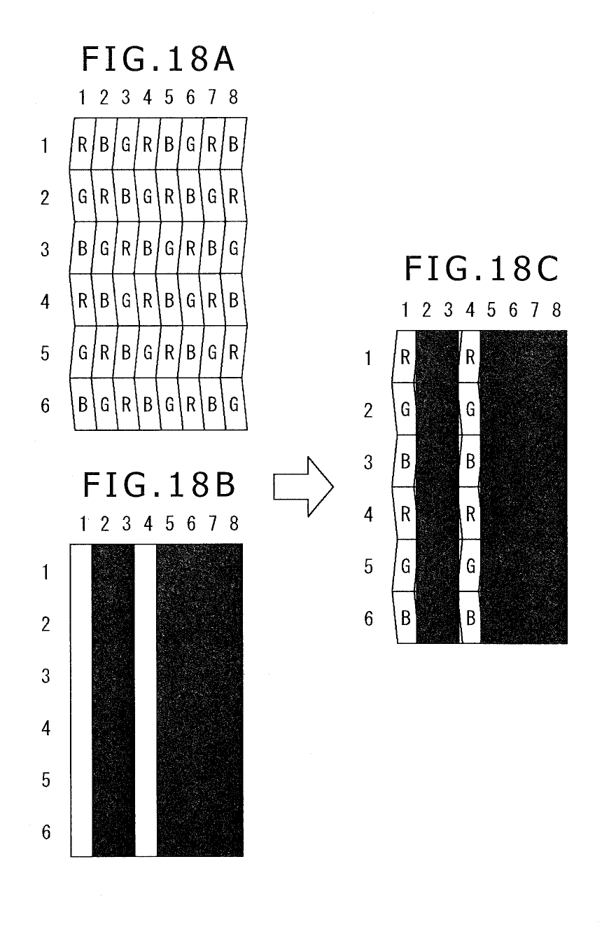

Not only the sub pixels having such shapes described above but also a sub pixel having a dual domain structure are applicable. Now, the display section 11 is described taking a case in which it is a FFS (Fringe-Field Switching) type color liquid crystal display section as an example. FIG. 18A is a top plan view showing a configuration and disposition of sub pixels of the display section 11.

Referring to FIG. 18A, the sub pixels R, G, B and W are configured in a shape in which a rectangle is bent at the center in the longitudinal direction. It is to be noted that, in FIG. 18A, pixels on the upper side and pixels on the lower side are shown in a divided relationship across the boundary at the bent portion (hereinafter referred to as bent portion).

In the example shown in FIG. 18A, while one pixel is configured from four sub pixels R, G, B and W, there is the possibility that, if two pixels positioned on the upper and lower sides of the bent portion are described as an upper sub pixel and a lower sub pixel, respectively, then the sub pixels may be configured in such a manner as described below.

In particular, a configuration wherein the upper sub pixel and the lower sub pixel are configured integrally and have the same color, another configuration wherein the sub pixels are configured separately and have the same color and a further configuration wherein the sub pixels are configured separately and have colors different from each other are available. In the following description, while the upper sub pixel and the lower sub pixel are configured separately from each other and are hereinafter referred to each as sub pixel, the present disclosure described below can be applied also to a case in which the upper sub pixel and the lower sub pixel are configured integrally.

The sub pixel R of the sub pixel 1-1 is disposed so as to be inclined rightwardly upwardly. The sub pixel G of the sub pixel 1-2 disposed under the sub pixel R is disposed so as to be inclined leftwardly upwardly. In other words, the sub pixels positioned at the upper and lower positions with respect to the bent portion on the boundary are bent so as to be inclined in the opposite directions to each other.

In the pixel disposition illustrated in FIG. 18A, the sub pixels disposed in the vertical direction and the horizontal direction are configured such that sub pixels of the three colors configuring one pixel are uniformly disposed. For example, in the vertical direction, the sub pixel R of the sub pixel 1-1, sub pixel G of the sub pixel 1-2 and sub pixel B of the sub pixel 1-3 are disposed so that the colors configuring one pixel are disposed. Further, for example, in the horizontal direction, the sub pixel R of the sub pixel 1-1, sub pixel G of the sub pixel 2-1 and sub pixel B of the sub pixel 3-1 are disposed so that the colors configuring one pixel are disposed.

Further, the sub pixels 1-1 to 8-1 shown at the uppermost stage of FIG. 18A are disposed so as to be inclined rightwardly upwardly, and the sub pixels 1-2 to 8-2 shown at the second stage from the top of FIG. 18A are disposed so as to be inclined leftwardly upwardly. Similarly, the sub pixels disposed so as to be inclined rightwardly upwardly and the sub pixels disposed so as to be inclined leftwardly upwardly are disposed alternately.

Further, as shown in FIG. 18A, the sub pixels are disposed in a displaced relationship one by one for each column. For example, if attention is paid to the sub pixels R, the sub pixel R in the next row to the sub pixel R disposed on the sub pixel 1-1 is disposed on the sub pixel 2-2, and the sub pixel R in the next row to the sub pixel 2-2 is disposed on the sub pixel 3-3. In this manner, together with downward advancement one by one in the vertical direction, the sub pixel is disposed at a position moved to the right side one by one sub pixel also in the horizontal direction.

FIG. 18B shows an example of the parallax barrier 12. The parallax barrier 12 shown in FIG. 18B has an opening of a linear shape. Since, in the parallax barrier 12 shown in FIG. 18B, the openings 1-1 to 1-6 are successively provided, the parallax barrier 12 is configured as a linearly opened parallax barrier. Similarly, since the openings 4-1 to 4-6 are successively provided, a linearly opened opening is provided in the parallax barrier 12. In this manner, the parallax barrier 12 is configured as a barrier in which the linear openings are provided in parallel to each other.

It is to be noted, while the following description is given assuming that the openings have a linear shape, the parallax barrier 12 may be configured in a shape in which openings inclined rightwardly upwardly or leftwardly upwardly are successively provided similarly to the sub pixels. In other words, each opening of the parallax barrier 12 may be configured in an L shape similarly to the sub pixels, or such parallel lines as shown in FIG. 18B may be applied. Also in other figures, an opening having a shape which coincides with that of the sub pixel can be applied similarly.

The display apparatus 10 is configured by overlapping the parallax barrier 12 shown in FIG. 18B on the display section 11 having the disposition of sub pixels shown in FIG. 18A. The display apparatus 10 and the parallax barrier 12 in the overlapping state are shown in FIG. 18C. Referring to FIG. 18C, the sub pixel R of the sub pixel 1-1 can be seen through the opening 1-1 of the parallax barrier 12 and the sub pixel G of the sub pixel 1-2 can be seen through the opening 1-2, and the sub pixel B of the sub pixel 1-3 can be seen through the opening 1-3. Also in the other openings, the sub pixels disposed corresponding thereto can be seen through the openings similarly.

Further, the sub pixel R of the sub pixel 1-1 can be seen through the opening 1-1 of the parallax barrier 12, and the sub pixel R of the sub pixel 1-4 can be seen through the opening 1-4 in the same slit as that of the opening 1-1. While both of the sub pixel R of the sub pixel 1-1 and the sub pixel R of the sub pixel 1-4 have the same color, since the inclination directions of the sub pixels R are different from each other, optical characteristics of the sub pixels R are different from each other. Also in the other sub pixels or colors, the sub pixels having the optical characteristics different from each other are disposed in the same slits.

When viewed from one predetermined viewpoint, such light from the sub pixel as shown in FIG. 18C is provided to the viewer. In this manner, in the parallax barrier 12 shown in FIG. 18B, the openings are provided so that sub pixels which configure one pixel such as sub pixels R, G and B become uniformized in the vertical direction in order to establish color balance of images of different parallaxes.

Further, when the sub pixels are viewed in the horizontal direction, both of the sub pixel R of the opening 1-1 and the sub pixel R of the opening 4-1 are inclined rightwardly upwardly and have the same characteristic. Similarly, both of the sub pixel G of the opening 1-2 and the sub pixel G of the opening 4-2 are inclined leftwardly upwardly and have the same characteristic. Also in the other openings, the sub pixels having the same colors and adjacent to each other in the horizontal direction have the same characteristics similarly.

In particular, in the sub pixels having the same colors in the linear-shaped opening which are adjacent to each other in the horizontal direction, the openings of the parallax barrier 12 are provided so that the sub pixels in the same domain, namely, the sub pixels having the same optical characteristic, are positioned therein.

In this manner, since the sub pixels disposed in the slit provided in the parallax barrier 12 are disposed uniformly while they have the optical characteristics different from each other, when a 3D image is to be provided, a 3D image which has high picture quality in that it has no offset of the color can be provided to the viewer.

Further, also when a 2D image is to be provided to the viewer, the image is provided by the display section 11 having the disposition of the pixels shown in FIG. 18A. Therefore, also in this case, due to the uniform disposition of the sub pixels having the optical characteristics different from each other, a 2D image which has high picture quality in that it has no offset of the color can be provided to the viewer.

In this manner, also where the dual domain structure is applied, by disposing the sub pixels having the same colors so as to avoid localization thereof, both a 2D image and a 3D image which have high picture quality in that they have no offset of the color can be provided to the viewer.

As the disposition of pixels in such a dual domain structure as shown in FIG. 18A, not only the disposition illustrated in FIG. 18A but also the dispositions of pixels described above can be applied. For example, the disposition of pixels shown in FIG. 5A can be applied also to that of the dual domain structure shown in FIG. 18A and also the parallax barrier 12 shown in FIG. 5B can be applied.

Further, for example, the disposition of pixels illustrated in FIG. 6A can be applied to the disposition of pixels of the dual domain structure shown in FIG. 18A and also the parallax barrier 12 shown in FIG. 6B can be applied. Further, for example, the disposition of pixels shown in FIG. 7A can be applied to the disposition of pixels of the dual domain structure shown in FIG. 18A and also the parallax barrier 12 shown in FIG. 7B can be applied.

Further, for example, the disposition of pixels illustrated in FIG. 9A can be applied to the disposition of pixels of the dual domain structure illustrated in FIG. 18A and also the parallax barrier 12 shown in any one of FIGS. 5B to 7B can be applied.

Further, for example, the disposition of pixels illustrated in any one of FIGS. 10A, 10B and 11 can be applied to the disposition of pixels of the dual domain structure illustrated in FIG. 18A and also the parallax barrier 12 shown in any one of FIGS. 5B and 6B can be applied.

Further, for example, the disposition of pixels illustrated in FIG. 12A can be applied to the disposition of pixels of the dual domain structure illustrated in FIG. 18A and also the parallax barrier 12 illustrated in FIG. 12B can be applied. Further, for example, the disposition of pixels illustrated in FIG. 13A can be applied to the disposition of pixels of the dual domain structure illustrated in FIG. 18A also and the parallax barrier 12 illustrated in FIG. 13B can be applied.

Further, for example, the disposition of pixels illustrated in FIG. 14A can be applied to the disposition of pixels of the dual domain structure illustrated in FIG. 18A and also the parallax barrier 12 illustrated in FIG. 5B can be applied.

Furthermore, as in the pixel dispositions illustrated in FIGS. 15A to 17A, the disposition of spacers and so forth can be applied also to the disposition of pixels of the dual domain structure illustrated in FIG. 18A.

In any case, when a 2D image is to be provided to the viewer, since the image can be provided by the display section 11 wherein pixels are disposed uniformly without being localized, it can be provided with high picture quality. Also when a 3D image is to be provided to the viewer, since the image can be provided by the display section 11 and the parallax barrier 12 wherein pixels are disposed uniformly without being localized in openings or slits provided in the parallax barrier 12 and also pixels of different optical characteristics are disposed uniformly, it can be provided with high picture quality.

### Application of the Display Apparatus

The display apparatus 10 described hereinabove has a form of a flat panel and can be applied to various electronic apparatus such as, for example, a digital camera, a notebook type personal computer, a portable telephone set and a video camera. Particularly, the display apparatus 10 can be applied to a display unit of an electronic apparatus in all fields wherein a driving signal inputted to the electronic apparatus or generated in the electronic apparatus is displayed as an image or video. Examples of such an apparatus to which the display apparatus is applied as just described are described below. The electronic apparatus basically includes a main body which processes information, and a display unit for displaying information inputted to the main body or information outputted from the may body.

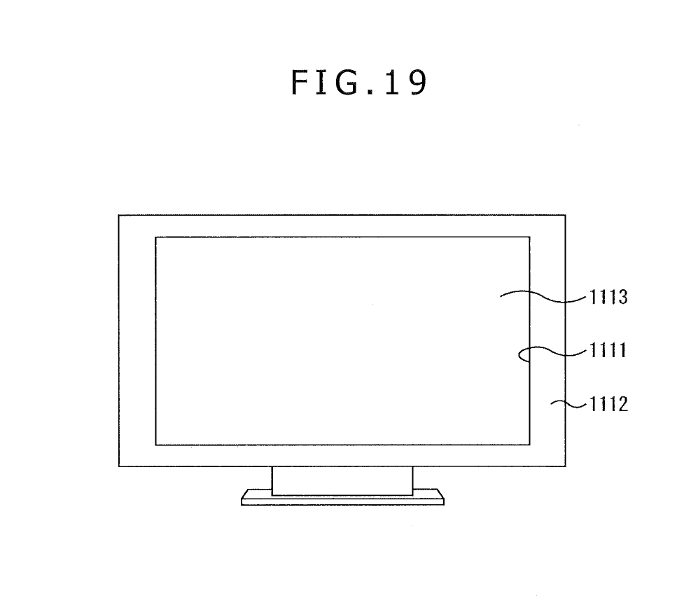

FIG. 19 shows a television receiver to which the present technology is applied. Referring to FIG. 19, the television receiver shown includes a video displaying screen 1111 configured from a front panel 1112, a glass filter 1113 and so forth and is fabricated applying the display apparatus 10 of the present technology to the video displaying screen 1111. Through the video displaying screen 1111 configured from the display apparatus 10, for example, a 3D image is provided to the user.

The present technology can be applied also to a notebook type personal computer. The main body of the notebook type personal computer includes a keyboard which is operated when a character or the like is to be inputted, and a main body cover which includes a display section for displaying an image. The notebook type personal computer is fabricated applying the display apparatus 10 of the present technology to the display section thereof. Through the display section configured from the display apparatus 10, for example, a 3D image is provided to the user.

The present technology can be applied also to a portable terminal apparatus. The portable terminal apparatus includes an upper side housing member, a lower side housing member, a connection member such as, for example, a hinge member, a display unit, a sub display unit, a picture light, a camera and so forth. The portable terminal apparatus is fabricated applying the display apparatus 10 to the display unit or the sub display unit. Through the display unit or the sub display unit configured from the display apparatus 10, for example, a 3D image is provided to the user.

The present technology can be applied also to a video camera. The video camera includes a main body section, a lens provided on a side face directed forwardly for picking up an image of an image pickup object, a start/stop switch for image pickup, a monitor and so forth. The video camera is fabricated applying the display apparatus 10 of the present technology to the monitor. Through the monitor configured from the display apparatus 10, for example, a 3D image is provided to the user.

The foregoing description of the embodiment is given taking the display apparatus 10 as an example. However, this does not signify that the application of the present technology is restricted to a display apparatus such as the display apparatus 10. For example, the present technology can be applied also to a display apparatus of the organic EL type. Further, the present technology can be applied also to a multi screen display apparatus on which screen images of different angles of view can be viewed.

It is to be noted that the embodiment of the present technology is not limited to the embodiment described hereinabove but can be modified or altered in various manners without departing from the subject matter of the present technology.

It is to be noted that the present technology can take such configurations as described below.

(1)

A display apparatus, including:

a display section in which pixels each configured from a plurality of sub pixels of colors different from each other are disposed; and

an optical device laminated on the display section and configured to control a direction of a light ray from the display section; wherein

the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

(2)

The display apparatus according to (1) above, wherein each of the pixels is configured from sub pixels of the four colors disposed in a 2×2 matrix, and

the pixels are disposed at positions displaced by a distance of a sub pixel for each row in a unit of the pixel.

(3)

The display apparatus according to (2) above, wherein the optical device includes an opening for allowing the light ray from the display section to pass to a predetermined direction therethrough, and the opening has a linear shape in a vertical, horizontal or oblique direction having a width substantially equal to that of a sub pixel or another width of a substantially integral multiple of that of the sub pixel.

(4)

The display apparatus according to (1) above, wherein, where all of the colors of the sub pixels exhibit the repetitions in the vertical direction of the display section, the disposition of the sub pixels is different between the columns adjacent each other.

(5)

The display apparatus according to (1) above, wherein the sub pixels of the same colors are disposed successively in an obliquely leftward direction or an obliquely rightward direction.

(6)

The display apparatus according to (1) above, wherein each of the pixels is configured from sub pixels of the four colors disposed in a 2×2 matrix; and

the pixels include first pixels and second pixels between which the disposition of the colors of the sub pixels differs from each other and which are disposed in the vertical direction separately from each other and are disposed alternately in the horizontal direction.

(7)

The display apparatus according to (1) above, wherein the sub pixels which configure one pixel are disposed successively in an obliquely leftward direction or an obliquely rightward direction.

(8)

The display apparatus according to (7) above, wherein the optical device has an opening or openings for allowing the light ray from the display section to pass to the predetermined direction therethrough and the opening has a stepped shape; and

the size of one opening is equal to that of one or a plurality of sub pixels.

(9)

The display apparatus according to (1) above, wherein spacers are disposed in a direction same as the direction in which the sub pixels of the same colors are disposed.

(10)

The display apparatus according to (9) above, wherein the optical device has an opening or openings for allowing the light ray from the display section pass to the predetermined direction therethrough, and the spacers are disposed uniformly in the openings.

(11)

The display apparatus according to (1) above, wherein the pixels of the display section are disposed in a dual domain structure.

(12)

An electronic apparatus, including:

a display section in which pixels each configured from a plurality of sub pixels of colors different from each other are disposed; and

an optical device laminated on the display section and configured to control a direction of a light ray from the display section; wherein

the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

The present disclosure contains subject matter related to that disclosed in Japanese Priority Patent Application JP 2012-067937 filed in the Japan Patent Office on Mar. 23, 2012, the entire content of which is hereby incorporated by reference.

It should be understood by those skilled in the art that various modifications, combinations, sub-combinations and alterations may occur depending on design requirements and other factors in so far as they are within the scope of the appended claims or the equivalents thereof.

What is claimed is:

1. A display apparatus, comprising:
a display section in which pixels each configured from a plurality of sub pixels of colors different from each other are disposed; and
an optical device laminated on the display section and configured to control a direction of a light ray from the display section; wherein
the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.

2. The display apparatus according to claim 1, wherein each of the pixels is configured from sub pixels of the four colors disposed in a 2×2 matrix, and
the pixels are disposed at positions displaced by a distance of a sub pixel for each row in a unit of the pixel.

3. The display apparatus according to claim 2, wherein the optical device includes an opening for allowing the light ray from the display section to pass to a predetermined direction therethrough, and the opening has a linear shape in a vertical, horizontal or oblique direction having a width substantially equal to that of a sub pixel or another width of a substantially integral multiple of that of the sub pixel.

4. The display apparatus according to claim 1, wherein, where all of the colors of the sub pixels exhibit the repetitions in the vertical direction of the display section, the disposition of the sub pixels is different between the columns adjacent each other.

5. The display apparatus according to claim 1, wherein the sub pixels of the same colors are disposed successively in an obliquely leftward direction or an obliquely rightward direction.

6. The display apparatus according to claim 1, wherein each of the pixels is configured from sub pixels of the four colors disposed in a 2×2 matrix; and
the pixels include first pixels and second pixels between which the disposition of the colors of the sub pixels differs from each other and which are disposed in the vertical direction separately from each other and are disposed alternately in the horizontal direction.

7. The display apparatus according to claim 1, wherein the sub pixels which configure one pixel are disposed successively in an obliquely leftward direction or an obliquely rightward direction.

8. The display apparatus according to claim 7, wherein the optical device has an opening or openings for allowing the light ray from the display section to pass to the predetermined direction therethrough and the opening has a stepped shape; and
the size of one opening is equal to that of one or a plurality of sub pixels.

9. The display apparatus according to claim 1, wherein spacers are disposed in a direction same as the direction in which the sub pixels of the same colors are disposed.

10. The display apparatus according to claim 9, wherein the optical device has an opening or openings for allowing the light ray from the display section pass to the predetermined direction therethrough, and the spacers are disposed uniformly in the openings.

11. The display apparatus according to claim 1, wherein the pixels of the display section are disposed in a dual domain structure.

12. An electronic apparatus, comprising:
a display section in which pixels each configured from a plurality of sub pixels of colors different from each other are disposed; and
an optical device laminated on the display section and configured to control a direction of a light ray from the display section; wherein
the sub pixels are disposed at positions at which repetitions of all of the colors of the sub pixels are provided in at least one of a horizontal direction and a vertical direction of the display section and distances between the sub pixels having the same colors and adjacent from each other are substantially equal to each other.
